(19) United States
(12) Patent Application Publication
(10) Pub. No.: US 2016/0130400 A1
(43) Pub. Date: May 12, 2016

(54) CONTINUOUS PROCESS FOR PRODUCING POLY(ARYLENE SULFIDE)

(71) Applicant: SOLVAY SA, Brussels (BE)

(72) Inventor: Jeffrey S. Fodor, Bartlesville, OK (US)

(21) Appl. No.: 14/534,914

(22) Filed: Nov. 6, 2014

(51) Int. Cl. C08G 75/14

(52) U.S. Cl. CPC C08G 75/14

(57) ABSTRACT

A process comprising (a) contacting a sulfur compound and a polar organic compound to produce a sulfur complex mixture, wherein the sulfur complex mixture comprises a sulfur complex, (b) continuously introducing at least a portion of the sulfur complex mixture and at least one halogenated aromatic compound having two halogens to a reaction vessel to form a reaction mixture, wherein the reaction vessel is continuously stirred, and wherein the reaction vessel comprises a single reaction zone, (c) continuously removing a portion of the reaction mixture from the reaction vessel to yield a reaction product mixture, and (d) processing at least a portion of the reaction product mixture to obtain a poly(arylene sulfide) polymer, wherein the poly(arylene sulfide) polymer is the product of a single stage polymerization.

### TECHNICAL FIELD

The present disclosure relates to a process of producing polymers, more specifically poly(arylene sulfide) polymers.

### BACKGROUND

Polymers, such as poly(arylene sulfide) polymers and their derivatives, are used for the production of a wide variety of articles. Generally, the process for producing a particular polymer and any steps thereof can drive the cost of such particular polymer, and consequently influences the economics of polymer articles. Thus, there is an ongoing need to develop and/or improve processes for producing these polymers.

### BRIEF SUMMARY

Disclosed herein is a process comprising (a) contacting a sulfur compound and a polar organic compound to produce a sulfur complex mixture, wherein the sulfur complex mixture comprises a sulfur complex, (b) continuously introducing at least a portion of the sulfur complex mixture and at least one halogenated aromatic compound having two halogens to a reaction vessel to form a reaction mixture, wherein the reaction vessel is continuously stirred, and wherein the reaction vessel comprises a single reaction zone, (c) continuously removing a portion of the reaction mixture from the reaction vessel to yield a reaction product mixture, and (d) processing at least a portion of the reaction product mixture to obtain a poly(arylene sulfide) polymer, wherein the poly(arylene sulfide) polymer is the product of a single stage polymerization.

Also disclosed herein is a process comprising (a) contacting sodium hydrosulfide, N-methyl-2-pyrrolidone, acetic anhydride and sodium hydroxide to produce a sulfur complex mixture, wherein the sulfur complex mixture comprises sodium N-methyl-4-aminobutanoate, (b) dehydrating at least a portion of the sulfur complex mixture to yield a dehydrated sulfur complex mixture, (c) continuously introducing at least a portion of the dehydrated sulfur complex mixture and p-dichlorobenzene to a reaction vessel to form a reaction mixture, wherein the reaction vessel is continuously stirred, and wherein the reaction vessel comprises a single reaction zone, (d) continuously removing a portion of the reaction mixture from the reaction vessel to yield a reaction product mixture, and (e) cooling at least a portion of the reaction product mixture to a temperature of less than about 200° C. to obtain a poly(phenylene sulfide) polymer, wherein the poly(phenylene sulfide) polymer is a single stage polymerization product, and wherein the poly(phenylene sulfide) polymer has a molecular weight distribution of from about 1,000 to about 90,000.

### BRIEF DESCRIPTION OF THE DRAWINGS

For a detailed description of the preferred embodiments of the disclosed processes, reference will now be made to the accompanying drawings in which:

FIG. 1 displays a schematic of an embodiment of a poly(arylene sulfide) polymer continuous production system;

FIG. 2 displays the terminology used for developing a mathematical model of Example 1;

FIG. 3 displays the reactions used for developing the mathematical model of Example 1;

FIG. 4 displays a system of equations used for developing the mathematical model of Example 1;

FIG. 5 displays equations for a chi parameter used for developing the mathematical model of Example 1;

FIG. 6 displays the equations used by the mathematical model of Example 1;

FIG. 7 displays a relationship between flow rate and molecular weight for a polymer simulated with the mathematical model of Example 1;

FIG. 8 displays an outline of a typical reaction model and recipe;

FIG. 9A displays a graph of weight average molecular weight over time for a continuous stirred tank reactor, wherein an average residence time was 4.65 h, and wherein the data was simulated with the mathematical model of Example 1;

FIG. 9B displays a graph of weight average molecular weight over time for a continuous stirred tank reactor, wherein an average residence time was 8.30 h, and wherein the data was simulated with the mathematical model of Example 1; and

FIG. 10 displays a graph of flow rate versus p-dichlorobenzene (DCB) to sulfur molar ratio for various residence times, wherein the data was simulated with the mathematical model of Example 1.

### DETAILED DESCRIPTION

Disclosed herein are processes for producing poly(arylene sulfide) polymers. The present application relates to poly(arylene sulfide) polymers, also referred to herein simply as “poly(arylene sulfide).” In the various embodiments disclosed herein, it is to be expressly understood that reference to poly(arylene sulfide) polymer specifically includes, without limitation, polyphenylene sulfide polymer (or simply, polyphenylene sulfide), also referred to as PPS polymer (or simply, PPS).

In an embodiment, a process for producing a poly(arylene sulfide) polymer comprises the steps of (a) contacting a sulfur compound and a polar organic compound to produce a sulfur complex mixture, wherein the sulfur complex mixture comprises a sulfur complex; (b) continuously introducing at least a portion of the sulfur complex mixture and at least one halogenated aromatic compound having two halogens to a reaction vessel to form a reaction mixture, wherein the reaction vessel is continuously stirred, and wherein the reaction vessel comprises a single reaction zone; (c) continuously removing a portion of the reaction mixture from the reaction vessel to yield a reaction product mixture; and (d) processing at least a portion of the reaction product mixture to obtain a poly(arylene sulfide) polymer, wherein the poly(arylene sulfide) polymer is the product of a single stage polymerization. In an embodiment, the process for producing a poly(arylene sulfide) polymer further comprises continuously forming poly(arylene sulfide) polymer particles by cooling at least a portion of the reaction product mixture to a temperature of less than about 200° C. In some embodiments, continuously forming poly(arylene sulfide) polymer particles comprises quenching at least a portion of the reaction product mixture by adding a quench liquid thereto to form a quenched mixture, wherein the quenched mixture comprises poly(arylene sulfide) polymer particles. In other embodiments, continuously forming poly(arylene sulfide) polymer particles comprises operating at least two flash units in parallel, wherein each flash unit removes at least a portion of a liquid phase of the reaction product mixture from at least a portion of the reaction product mixture to form a flashed poly(arylene sulfide) polymer mixture, wherein the flashed poly(arylene sulfide) polymer mixture comprises poly(arylene sulfide) polymer particles.

In an embodiment, a process of the present disclosure comprises a continuous process for producing a poly(arylene sulfide) polymer. While the present disclosure will be discussed in detail in the context of a process for producing a poly(arylene sulfide) polymer, it should be understood that such process or any steps thereof can be applied in a process for producing any other suitable polymer. The polymer can comprise any polymer compatible with the disclosed methods and materials.

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology, 2nd Ed. (1997) can be applied, as long as that definition does not conflict with any other disclosure or definition applied herein, or render indefinite or non-enabled any claim to which that definition is applied. To the extent that any definition or usage provided by any document incorporated herein by reference conflicts with the definition or usage provided herein, the definition or usage provided herein controls.

Groups of elements of the table are indicated using the numbering scheme indicated in the version of the periodic table of elements published in Chemical and Engineering News, 63(5), 27, 1985. In some instances a group of elements can be indicated using a common name assigned to the group; for example alkali earth metals (or alkali metals) for Group 1 elements, alkaline earth metals (or alkaline metals) for Group 2 elements, transition metals for Group 3-12 elements, and halogens for Group 17 elements.

A chemical “group” is described according to how that group is formally derived from a reference or “parent” compound, for example, by the number of hydrogen atoms formally removed from the parent compound to generate the group, even if that group is not literally synthesized in this manner. These groups can be utilized as substituents or coordinated or bonded to metal atoms. By way of example, an “alkyl group” formally can be derived by removing one hydrogen atom from an alkane, while an “alkylene group” formally can be derived by removing two hydrogen atoms from an alkane. Moreover, a more general term can be used to encompass a variety of groups that formally are derived by removing any number (“one or more”) hydrogen atoms from a parent compound, which in this example can be described as an “alkane group,” and which encompasses an “alkyl group,” an “alkylene group,” and materials have three or more hydrogen atoms, as necessary for the situation, removed from the alkane. Throughout, the disclosure that a substituent, ligand, or other chemical moiety can constitute a particular “group” implies that the well-known rules of chemical structure and bonding are followed when that group is employed as described. When describing a group as being “derived by,” “derived from,” “formed by,” or “formed from,” such terms are used in a formal sense and are not intended to reflect any specific synthetic methods or procedure, unless specified otherwise or the context requires otherwise.

The term “substituted” when used to describe a group, for example, when referring to a substituted analog of a particular group, is intended to describe any non-hydrogen moiety that formally replaces a hydrogen in that group, and is intended to be non-limiting. A group or groups can also be referred to herein as “unsubstituted” or by equivalent terms such as “non-substituted,” which refers to the original group in which a non-hydrogen moiety does not replace a hydrogen within that group. “Substituted” is intended to be non-limiting and include inorganic substituents or organic substituents.

Unless otherwise specified, any carbon-containing group for which the number of carbon atoms is not specified can have, according to proper chemical practice, 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 carbon atoms, or any range or combination of ranges between these values. For example, unless otherwise specified, any carbon-containing group can have from 1 to 30 carbon atoms, from 1 to 25 carbon atoms, from 1 to 20 carbon atoms, from 1 to 15 carbon atoms, from 1 to 10 carbon atoms, or from 1 to 5 carbon atoms, and the like. Moreover, other identifiers or qualifying terms can be utilized to indicate the presence or absence of a particular substituent, a particular regiochemistry and/or stereochemistry, or the presence or absence of a branched underlying structure or backbone.

Within this disclosure the normal rules of organic nomenclature will prevail. For instance, when referencing substituted compounds or groups, references to substitution patterns are taken to indicate that the indicated group(s) is (are) located at the indicated position and that all other non-indicated positions are hydrogen. For example, reference to a 4-substituted phenyl group indicates that there is a non-hydrogen substituent located at the 4 position and hydrogens located at the 2, 3, 5, and 6 positions. By way of another example, reference to a 3-substituted naphth-2-yl indicates that there is a non-hydrogen substituent located at the 3 position and hydrogens located at the 1, 4, 5, 6, 7, and 8 positions. References to compounds or groups having substitutions at positions in addition to the indicated position will be referenced using comprising or some other alternative language. For example, a reference to a phenyl group comprising a substituent at the 4 position refers to a group having a non-hydrogen atom at the 4 position and hydrogen or any non-hydrogen group at the 2, 3, 5, and 6 positions.

The term “organyl group” is used herein in accordance with the definition specified by IUPAC: an organic substituent group, regardless of functional type, having one free valence at a carbon atom. Similarly, an “organylene group” refers to an organic group, regardless of functional type, derived by removing two hydrogen atoms from an organic compound, either two hydrogen atoms from one carbon atom or one hydrogen atom from each of two different carbon atoms. An “organic group” refers to a generalized group formed by removing one or more hydrogen atoms from carbon atoms of an organic compound. Thus, an “organyl group,” an “organylene group,” and an “organic group” can contain organic functional group(s) and/or atom(s) other than carbon and hydrogen, that is, an organic group that can comprise functional groups and/or atoms in addition to carbon and hydrogen. For instance, non-limiting examples of atoms other than carbon and hydrogen include halogens, oxygen, nitrogen, phosphorus, and the like. Non-limiting examples of functional groups include ethers, aldehydes, ketones, esters, sulfides, amines, and phosphines, and so forth. In one aspect, the hydrogen atom(s) removed to form the “organyl group,” “organylene group,” or “organic group” can be attached to a carbon atom belonging to a functional group, for example, an acyl group (—C(O)R), a formyl group (—C(O)H), a carboxy group (—C(O)OH), a hydrocarboxycarbonyl group (—C(O)OR), a cyano group (—C≡N), a carbamoyl group (—C(O)NH₂), a N-hydrocarbylcarbamoyl group (—C(O)NHR), or N,N′-dihydrocarbylcarbamoyl group (—C(O)NR₂), among other possibilities. In another aspect, the hydrogen atom(s) removed to form the “organyl group,” “organylene group,” or “organic group” can be attached to a carbon atom not belonging to, and remote from, a functional group, for example, —CH₂C(O)CH₃, —CH₂NR₂. An “organyl group,” “organylene group,” or “organic group” can be aliphatic, inclusive of being cyclic or acyclic, or can be aromatic. “Organyl groups,” “organylene groups,” and “organic groups” also encompass heteroatom-containing rings, heteroatom-containing ring systems, heteroaromatic rings, and heteroaromatic ring systems. “Organyl groups,” “organylene groups,” and “organic groups” can be linear or branched unless otherwise specified. Finally, it is noted that the “organyl group,” “organylene group,” or “organic group” definitions include “hydrocarbyl group,” “hydrocarbylene group,” “hydrocarbon group,” respectively, and “alkyl group,” “alkylene group,” and “alkane group,” respectively, as members.

The term “hydrocarbon” whenever used in this specification and claims refers to a compound containing only carbon and hydrogen. Other identifiers can be utilized to indicate the presence of particular groups in the hydrocarbon (e.g. halogenated hydrocarbon indicates the presence of one or more halogen atoms replacing an equivalent number of hydrogen atoms in the hydrocarbon). The term “hydrocarbyl group” is used herein in accordance with the definition specified by IUPAC: a univalent group formed by removing a hydrogen atom from a hydrocarbon (that is, a group containing only carbon and hydrogen). Similarly, a “hydrocarbylene group” refers to a group formed by removing two hydrogen atoms from a hydrocarbon, either two hydrogen atoms from one carbon atom or one hydrogen atom from each of two different carbon atoms. Therefore, in accordance with the terminology used herein, a “hydrocarbon group” refers to a generalized group formed by removing one or more hydrogen atoms (as necessary for the particular group) from a hydrocarbon. A “hydrocarbyl group,” “hydrocarbylene group,” and “hydrocarbon group” can be acyclic or cyclic groups, and/or can be linear or branched. A “hydrocarbyl group,” “hydrocarbylene group,” and “hydrocarbon group” can include rings, ring systems, aromatic rings, and aromatic ring systems, which contain only carbon and hydrogen. “Hydrocarbyl groups,” “hydrocarbylene groups,” and “hydrocarbon groups” include, by way of example, aryl, arylene, arene groups, alkyl, alkylene, alkane group, cycloalkyl, cycloalkylene, cycloalkane groups, aralkyl, aralkylene, and aralkane groups, respectively, among other groups as members.

The term “alkane” whenever used in this specification and claims refers to a saturated hydrocarbon compound. Other identifiers can be utilized to indicate the presence of particular groups in the alkane (e.g. halogenated alkane indicates the presence of one or more halogen atoms replacing an equivalent number of hydrogen atoms in the alkane). The term “alkyl group” is used herein in accordance with the definition specified by IUPAC: a univalent group formed by removing a hydrogen atom from an alkane. Similarly, an “alkylene group” refers to a group formed by removing two hydrogen atoms from an alkane (either two hydrogen atoms from one carbon atom or one hydrogen atom from two different carbon atoms). An “alkane group” is a general term that refers to a group formed by removing one or more hydrogen atoms (as necessary for the particular group) from an alkane. An “alkyl group,” “alkylene group,” and “alkane group” can be acyclic or cyclic groups, and/or can be linear or branched unless otherwise specified.

A “cycloalkane” is a saturated cyclic hydrocarbon, with or without side chains, for example, cyclobutane. Other identifiers can be utilized to indicate the presence of particular groups in the cycloalkane (e.g. halogenated cycloalkane indicates the presence of one or more halogen atoms replacing an equivalent number of hydrogen atoms in the cycloalkane). Unsaturated cyclic hydrocarbons having one or more endocyclic double or triple bonds are called cycloalkenes and cycloalkynes, respectively. Cycloalkenes and cycloalkynes having only one, only two, and only three endocyclic double or triple bonds, respectively, can be identified by use of the term “mono,” “di,” and “tri within the name of the cycloalkene or cycloalkyne. Cycloalkenes and cycloalkynes can further identify the position of the endocyclic double or triple bonds. Other identifiers can be utilized to indicate the presence of particular groups in the cycloalkane (e.g. halogenated cycloalkane indicates that the presence of one or more halogen atoms replacing an equivalent number of hydrogen atoms in the cycloalkane).

A “cycloalkyl group” is a univalent group derived by removing a hydrogen atom from a ring carbon atom from a cycloalkane. For example, a 1-methylcyclopropyl group and a 2-methylcyclopropyl group are illustrated as follows.

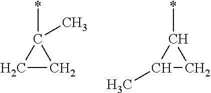

Similarly, a “cycloalkylene group” refers to a group derived by removing two hydrogen atoms from a cycloalkane, at least one of which is a ring carbon. Thus, a “cycloalkylene group” includes both a group derived from a cycloalkane in which two hydrogen atoms are formally removed from the same ring carbon, a group derived from a cycloalkane in which two hydrogen atoms are formally removed from two different ring carbons, and a group derived from a cycloalkane in which a first hydrogen atom is formally removed from a ring carbon and a second hydrogen atom is formally removed from a carbon atom that is not a ring carbon. A “cycloalkane group” refers to a generalized group formed by removing one or more hydrogen atoms (as necessary for the particular group and at least one of which is a ring carbon) from a cycloalkane. It should be noted that according to the definitions provided herein, general cycloalkane groups (including cycloalkyl groups and cycloalkylene groups) include those having zero, one, or more than one hydrocarbyl substituent groups attached to a cycloalkane ring carbon atom (e.g. a methylcyclopropyl group) and is member of the group of hydrocarbon groups. However, when referring to a cycloalkane group having a specified number of cycloalkane ring carbon atoms (e.g. cyclopentane group or cyclohexane group, among others), the base name of the cycloalkane group having a defined number of cycloalkane ring carbon atoms refers to the unsubstituted cycloalkane group. Consequently, a substituted cycloalkane group having a specified number of ring carbon atoms (e.g. substituted cyclopentane or substituted cyclohexane, among others) refers to the respective group having one or more substituent groups (including halogens, hydrocarbyl groups, or hydrocarboxy groups, among other substituent groups) attached to a cycloalkane group ring carbon atom. When the substituted cycloalkane group having a defined number of cycloalkane ring carbon atoms is a member of the group of hydrocarbon groups (or a member of the general group of cycloalkane groups), each substituent of the substituted cycloalkane group having a defined number of cycloalkane ring carbon atoms is limited to hydrocarbyl substituent group. One can readily discern and select general groups, specific groups, and/or individual substituted cycloalkane group(s) having a specific number of ring carbons atoms which can be utilized as member of the hydrocarbon group (or a member of the general group of cycloalkane groups).

An aromatic compound is a compound containing a cyclically conjugated double bond system that follows the Hückel (4n+2) rule and contains (4n+2) pi-electrons, where n is an integer from 1 to 5. Aromatic compounds include “arenes” (hydrocarbon aromatic compounds) and “heteroarenes,” also termed “hetarenes” (heteroaromatic compounds formally derived from arenes by replacement of one or more methine (—C═) carbon atoms of the cyclically conjugated double bond system with a trivalent or divalent heteroatoms, in such a way as to maintain the continuous pi-electron system characteristic of an aromatic system and a number of out-of-plane pi-electrons corresponding to the Hückel rule (4n+2). While arene compounds and heteroarene compounds are mutually exclusive members of the group of aromatic compounds, a compound that has both an arene group and a heteroarene group are generally considered a heteroarene compound. Aromatic compounds, arenes, and heteroarenes can be monocyclic (e.g., benzene, toluene, furan, pyridine, methylpyridine) or polycyclic unless otherwise specified. Polycyclic aromatic compounds, arenes, and heteroarenes, include, unless otherwise specified, compounds wherein the aromatic rings can be fused (e.g., naphthalene, benzofuran, and indole), compounds where the aromatic groups can be separate and joined by a bond (e.g., biphenyl or 4-phenylpyridine), or compounds where the aromatic groups are joined by a group containing linking atoms (e.g., carbon—the methylene group in diphenylmethane; oxygen—diphenyl ether; nitrogen—triphenyl amine; among others linking groups). As disclosed herein, the term “substituted” can be used to describe an aromatic group, arene, or heteroarene wherein a non-hydrogen moiety formally replaces a hydrogen in the compound, and is intended to be non-limiting.

An “aromatic group” refers to a generalized group formed by removing one or more hydrogen atoms (as necessary for the particular group and at least one of which is an aromatic ring carbon atom) from an aromatic compound. For a univalent “aromatic group,” the removed hydrogen atom must be from an aromatic ring carbon. For an “aromatic group” formed by removing more than one hydrogen atom from an aromatic compound, at least one hydrogen atom must be from an aromatic hydrocarbon ring carbon. Additionally, an “aromatic group” can have hydrogen atoms removed from the same ring of an aromatic ring or ring system (e.g., phen-1,4-ylene, pyridin-2,3-ylene, naphth-1,2-ylene, and benzofuran-2,3-ylene), hydrogen atoms removed from two different rings of a ring system (e.g., naphth-1,8-ylene and benzofuran-2,7-ylene), or hydrogen atoms removed from two isolated aromatic rings or ring systems (e.g., bis(phen-4-ylene)methane).

An arene is aromatic hydrocarbon, with or without side chains (e.g. benzene, toluene, or xylene, among others). An “aryl group” is a group derived by the formal removal of a hydrogen atom from an aromatic ring carbon of an arene. It should be noted that the arene can contain a single aromatic hydrocarbon ring (e.g., benzene, or toluene), contain fused aromatic rings (e.g., naphthalene or anthracene), and/or contain one or more isolated aromatic rings covalently linked via a bond (e.g., biphenyl) or non-aromatic hydrocarbon group(s) (e.g., diphenylmethane). One example of an “aryl group” is ortho-tolyl (o-tolyl), the structure of which is shown here.

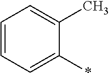 [SMILES: *c1ccccc1C]

Similarly, an “arylene group” refers to a group formed by removing two hydrogen atoms (at least one of which is from an aromatic ring carbon) from an arene. An “arene group” refers to a generalized group formed by removing one or more hydrogen atoms (as necessary for the particular group and at least one of which is an aromatic ring carbon) from an arene. However, if a group contains separate and distinct arene and heteroarene rings or ring systems (e.g., the phenyl and benzofuran moieties in 7-phenylbenzofuran) its classification depends upon the particular ring or ring system from which the hydrogen atom was removed, that is, a substituted arene group if the removed hydrogen came from the aromatic hydrocarbon ring or ring system carbon atom (e.g., the 2 carbon atom in the phenyl group of 6-phenylbenzofuran) and a heteroarene group if the removed hydrogen carbon came from a heteroaromatic ring or ring system carbon atom (e.g., the 2 or 7 carbon atom of the benzofuran group of 6-phenylbenzofuran). It should be noted that according the definitions provided herein, general arene groups (including an aryl group and an arylene group) include those having zero, one, or more than one hydrocarbyl substituent groups located on an aromatic hydrocarbon ring or ring system carbon atom (e.g., a toluene group or a xylene group, among others) and is a member of the group of hydrocarbon groups. However, a phenyl group (or phenylene group) and/or a naphthyl group (or naphthylene group) refer to the specific unsubstituted arene groups. Consequently, a substituted phenyl group or substituted naphthyl group refers to the respective arene group having one or more substituent groups (including halogens, hydrocarbyl groups, or hydrocarboxy groups, among others) located on an aromatic hydrocarbon ring or ring system carbon atom. When the substituted phenyl group and/or substituted naphthyl group is a member of the group of hydrocarbon groups (or a member of the general group of arene groups), each substituent is limited to a hydrocarbyl substituent group. One having ordinary skill in the art can readily discern and select general phenyl and/or naphthyl groups, specific phenyl and/or naphthyl groups, and/or individual substituted phenyl or substituted naphthyl groups which can be utilized as a member of the group of hydrocarbon groups (or a member of the general group of arene groups).

Regarding claim transitional terms or phrases, the transitional term “comprising”, which is synonymous with “including,” “containing,” “having,” or “characterized by,” is inclusive or open-ended and does not exclude additional, unrecited elements or method steps. The transitional phrase “consisting of” excludes any element, step, or ingredient not specified in the claim. The transitional phrase “consisting essentially of” limits the scope of a claim to the specified materials or steps and those that do not materially affect the basic and novel characteristic(s) of the claimed invention. The term “consisting essentially of” occupies a middle ground between closed terms like “consisting of” and fully open terms like “comprising.” Absent an indication to the contrary, when describing a compound or composition “consisting essentially of” is not to be construed as “comprising,” but is intended to describe the recited component that includes materials which do not significantly alter composition or method to which the term is applied. For example, a feedstock consisting essentially of a material A can include impurities typically present in a commercially produced or commercially available sample of the recited compound or composition. When a claim includes different features and/or feature classes (for example, a method step, feedstock features, and/or product features, among other possibilities), the transitional terms comprising, consisting essentially of, and consisting of apply only to feature class to which is utilized and it is possible to have different transitional terms or phrases utilized with different features within a claim. For example a method can comprise several recited steps (and other non-recited steps) but utilize a catalyst system preparation consisting of specific or alternatively consisting essentially of specific steps but utilize a catalyst system comprising recited components and other non-recited components.

While compositions and methods are described in terms of “comprising” (or other broad term) various components and/or steps, the compositions and methods can also be described using narrower terms such as “consist essentially of” or “consist of” the various components and/or steps.

Use of the term “optionally” with respect to any element of a claim is intended to mean that the subject element is required, or alternatively, is not required. Both alternatives are intended to be within the scope of the claim.

The terms “a,” “an,” and “the” are intended, unless specifically indicated otherwise, to include plural alternatives, e.g., at least one. For any particular compound or group disclosed herein, any name or structure presented is intended to encompass all conformational isomers, regioisomers, and stereoisomers that can arise from a particular set of substituents, unless otherwise specified. For example, a general reference to pentane includes n-pentane, 2-methyl-butane, and 2,2-dimethylpropane and a general reference to a butyl group includes an n-butyl group, a sec-butyl group, an iso-butyl group, and t-butyl group. The name or structure also encompasses all enantiomers, diastereomers, and other optical isomers whether in enantiomeric or racemic forms, as well as mixtures of stereoisomers, as would be recognized by a skilled artisan, unless otherwise specified.

The terms “room temperature” or “ambient temperature” are used herein to describe any temperature from 15° C. to 35° C. wherein no external heat or cooling source is directly applied to the reaction vessel. Accordingly, the terms “room temperature” and “ambient temperature” encompass the individual temperatures and any and all ranges, subranges, and combinations of subranges of temperatures from 15° C. to 35° C. wherein no external heating or cooling source is directly applied to the reaction vessel. The term “atmospheric pressure” is used herein to describe an earth air pressure wherein no external pressure modifying means is utilized. Generally, unless practiced at extreme earth altitudes, “atmospheric pressure” is about 1 atmosphere (alternatively, about 14.7 psi or about 101 kPa).

Features within this disclosure that are provided as a minimum values can be alternatively stated as “at least” or “greater than or equal to” any recited minimum value for the feature disclosed herein. Features within this disclosure that are provided as a maximum values can be alternatively stated as “less than or equal to” any recited maximum value for the feature disclosed herein.

Embodiments disclosed herein can provide the materials listed as suitable for satisfying a particular feature of the embodiment delimited by the term “or.” For example, a particular feature of the disclosed subject matter can be disclosed as follows: Feature X can be A, B, or C. It is also contemplated that for each feature the statement can also be phrased as a listing of alternatives such that the statement “Feature X is A, alternatively B, or alternatively C” is also an embodiment of the present disclosure whether or not the statement is explicitly recited.

In an embodiment, the polymers disclosed herein are poly(arylene sulfide) polymers. In an embodiment, the polymer can comprise a poly(arylene sulfide). In other embodiments, the polymer can comprise a poly(phenylene sulfide). Herein, the polymer refers both to a material collected as the product of a polymerization reaction (e.g., a reactor or virgin resin) and a polymeric composition comprising a polymer and one or more additives. In an embodiment, a monomer (e.g., p-dichlorobenzene) can be polymerized using the methodologies disclosed herein to produce a polymer of the type disclosed herein. In an embodiment, the polymer can comprise a homopolymer or a copolymer. It is to be understood that an inconsequential amount of comonomer can be present in the polymers disclosed herein and the polymer still be considered a homopolymer. Herein an inconsequential amount of a comonomer refers to an amount that does not substantively affect the properties of the polymer disclosed herein. For example a comonomer can be present in an amount of less than about 1.0 wt. %, 0.5 wt. %, 0.1 wt. %, or 0.01 wt. %, based on the total weight of polymer.

Generally, poly(arylene sulfide) is a polymer comprising a —(Ar—S)— repeating unit, wherein Ar is an arylene group. Unless otherwise specified the arylene groups of the poly(arylene sulfide) can be substituted or unsubstituted; alternatively, substituted; or alternatively, unsubstituted. Additionally, unless otherwise specified, the poly(arylene sulfide) can include any isomeric relationship of the sulfide linkages in polymer; e.g., when the arylene group is a phenylene group the sulfide linkages can be ortho, meta, para, or combinations thereof.

In an aspect, poly(arylene sulfide) can contain at least 5, 10, 20, 30, 40, 50, 60, 70 mole percent of the —(Ar—S)— unit. In an embodiment, the poly(arylene sulfide) can contain up to 50, 70, 80, 90, 95, 99, or 100 mole percent of the —(Ar—S)— unit. In some embodiments, poly(arylene sulfide) can contain from any minimum mole percent of the —(Ar—S)— unit disclosed herein to any maximum mole percent of the —(Ar—S)— unit disclosed herein; for example, from 5 to 99 mole percent, 30 to 70 mole percent, or 70 to 95 mole percent of the —(Ar—S)— unit. Other ranges for the poly(arylene sulfide) units are readily apparent from the present disclosure. Poly(arylene sulfide) containing less than 100 percent —(Ar—S)— can further comprise units having one or more of the following structures, wherein (*) as used throughout the disclosure represents a continuing portion of a polymer chain or terminal group:

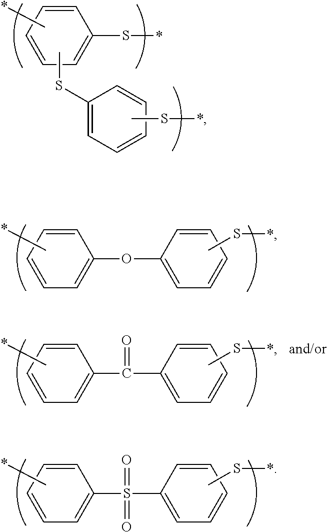

In an embodiment, the arylene sulfide unit can be represented by Formula I.

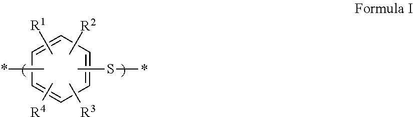

It should be understood, that within the arylene sulfide unit having Formula I, the relationship between the position of the sulfur atom of the arylene sulfide unit and the position where the next arylene sulfide unit can be ortho, meta, para, or any combination thereof. Generally, the identity of R¹, R², R³, and R⁴ are independent of each other and can be any group described herein.

In an embodiment, R¹, R², R³, and R⁴ independently can be hydrogen or a substituent. In some embodiments, each substituent independently can be an organyl group, an organocarboxy group, or an organothio group; alternatively, an organyl group or an organocarboxy group; alternatively, an organyl group or an organothio group; alternatively, an organyl group; alternatively, an organocarboxy group; or alternatively, or an organothio group. In other embodiments, each substituent independently can be a hydrocarbyl group, a hydrocarboxy group, or a hydrocarbylthio group; alternatively, a hydrocarbyl group or a hydrocarboxy group; alternatively, a hydrocarbyl group or a hydrocarbylthio group; alternatively, a hydrocarbyl group; alternatively, a hydrocarboxy group; or alternatively, or a hydrocarbylthio group. In yet other embodiments, each substituent independently can be an alkyl group, an alkoxy group, or an alkylthio group; alternatively, an alkyl group or an alkoxy group; alternatively, an alkyl group or an alkylthio group; alternatively, an alkyl group; alternatively, an alkoxy group; or alternatively, or an alkylthio group.

In an embodiment, each organyl group which can be utilized as R¹, R², R³, and/or R⁴ independently can be a C₁ to C₂₀ organyl group; alternatively, a C₁ to C₁₀ organyl group; or alternatively, a C₁ to C₅ organyl group. In an embodiment, each organocarboxy group which can be utilized as R¹, R², R³, and/or R⁴ independently can be a C₁ to C₂₀ organocarboxy group; alternatively, a C₁ to C₁₀ organocarboxy group; or alternatively, a C₁ to C₅ organocarboxy group. In an embodiment, each organothio group which can be utilized as R¹, R², R³, and/or R⁴ independently can be a C₁ to C₂₀ organothio group; alternatively, a C₁ to C₁₀ organothio group; or alternatively, a C₁ to C₅ organothio group. In an embodiment, each hydrocarbyl group which can be utilized as R¹, R², R³, and/or R⁴ independently can be a C₁ to C₂₀ hydrocarbyl group; alternatively, a C₁ to C₁₀ hydrocarbyl group; or alternatively, a C₁ to C₅ hydrocarbyl group. In an embodiment, each hydrocarboxy group which can be utilized as R¹, R², R³, and/or R⁴ independently can be a C₁ to C₂₀ hydrocarboxy group; alternatively, a C₁ to C₁₀ hydrocarboxy group; or alternatively, a C₁ to C₅ hydrocarboxy group. In an embodiment, each hydrocarbyl group which can be utilized as R¹, R², R³, and/or R⁴ independently can be a C₁ to C₂₀ hydrocarbylthio group; alternatively, a C₁ to C₁₀ hydrocarbylthio group; or alternatively, a C₁ to C₅ hydrocarbylthio group. In an embodiment, each alkyl group which can be utilized as R¹, R², R³, and/or R⁴ independently can be a C₁ to C₂₀ alkyl group; alternatively, a C₁ to C₁₀ alkyl group; or alternatively, a C₁ to C₅ alkyl group. In an embodiment, each alkoxy group which can be utilized as R¹, R², R³, and/or R⁴ independently can be a C₁ to C₂₀ alkoxy group; alternatively, a C₁ to C₁₀ alkoxy group; or alternatively, a C₁ to C₅ alkoxy group. In an embodiment, each alkoxy group which can be utilized as R¹, R², R³, and/or R⁴ independently can be a C₁ to C₂₀ alkylthio group; alternatively, a C₁ to C₁₀ alkylthio group; or alternatively, a C₁ to C₅ alkylthio group.

In some embodiments, each non-hydrogen R¹, R², R³, and/or R⁴ independently can be an alkyl group, a substituted alkyl group, a cycloalkyl group, a substituted cycloalkyl group, an aryl group, a substituted aryl group, an aralkyl group, or a substituted aralkyl group. In other embodiments, each non-hydrogen R¹, R², R³, and/or R⁴ independently can be an alkyl group or a substituted alkyl group; alternatively, a cycloalkyl group or a substituted cycloalkyl group; alternatively, an aryl group or a substituted aryl group; or alternatively, a aralkyl group or a substitute aralkyl group. In yet other embodiments, each non-hydrogen R¹, R², R³, and/or R⁴ independently can be an alkyl group; alternatively, a substituted alkyl group; alternatively, a cycloalkyl group; alternatively, a substituted cycloalkyl group; alternatively, an aryl group; alternatively, a substituted aryl group; alternatively, an aralkyl group; or alternatively, a substituted aralkyl group. Generally, the alkyl group, substituted alkyl group, cycloalkyl group, substituted cycloalkyl group, aryl group, substituted aryl group, aralkyl group, and substituted aralkyl group which can be utilized as R can have the same number of carbon atoms as any organyl group or hydrocarbyl group of which it is a member.

In an embodiment, each non-hydrogen R¹, R², R³, and/or R⁴ independently a methyl group, an ethyl group, a propyl group, a butyl group, a pentyl group, a hexyl group, a heptyl group, an octyl group, a nonyl group, or a decyl group. In some embodiments, each non-hydrogen R¹, R², R³, and/or R⁴ independently can be a methyl group, an ethyl group, a n-propyl group, an iso-propyl group, a n-butyl group, an iso-butyl group, a sec-butyl group, a tert-butyl group, an n-pentyl group, an iso-pentyl group, a sec-pentyl group, or a neopentyl group; alternatively, a methyl group, an ethyl group, an iso-propyl group, a tert-butyl group, or a neopentyl group; alternatively, a methyl group; alternatively, an ethyl group; alternatively, a n-propyl group; alternatively, an iso-propyl group; alternatively, a tert-butyl group; or alternatively, a neopentyl group. In some embodiments, any of the disclosed alkyl groups can be substituted. Substituents for the substituted alkyl group are independently disclosed herein and can be utilized without limitation to further describe the substituted alkyl group which can be utilized as a non-hydrogen R¹, R², R³, and/or R⁴.

In an aspect, each cycloalkyl group (substituted or unsubstituted) which can be utilized as a non-hydrogen R¹, R², R³, and/or R⁴ independently can be a C₄ to C₂₀ cycloalkyl group (substituted or unsubstituted); alternatively, a C₅ to C₁₅ cycloalkyl group (substituted or unsubstituted); or alternatively, a C₅ to C₁₀ cycloalkyl group (substituted or unsubstituted). In an embodiment, each non-hydrogen R¹, R², R³, and/or R⁴ independently can be a cyclobutyl group, a substituted cyclobutyl group, a cyclopentyl group, a substituted cyclopentyl group, a cyclohexyl group, a substituted cyclohexyl group, a cycloheptyl group, a substituted cycloheptyl group, a cyclooctyl group, or a substituted cyclooctyl group. In other embodiments, each non-hydrogen R¹, R², R³, and/or R⁴ independently can be a cyclopentyl group, a substituted cyclopentyl group, a cyclohexyl group, or a substituted cyclohexyl group; alternatively, a cyclopentyl group or a substituted cyclopentyl group; or alternatively, a cyclohexyl group or a substituted cyclohexyl group. In further embodiments, each non-hydrogen R¹, R², R³, and/or R⁴ independently can be a cyclopentyl group; alternatively, a substituted cyclopentyl group; a cyclohexyl group; or alternatively, a substituted cyclohexyl group. Substituents for the substituted cycloalkyl group are independently disclosed herein and can be utilized without limitation to further describe the substituted cycloalkyl group which can be utilized as a non-hydrogen R group. Substituents for the substituted cycloalkyl groups (general or specific) are independently disclosed herein and can be utilized without limitation to further describe the substituted cycloalkyl groups which can be utilized as a non-hydrogen R¹, R², R³, and/or R⁴.

In an aspect, the aryl group (substituted or unsubstituted) which can be utilized as a non-hydrogen R¹, R², R³, and/or R⁴ independently can be a C₆-C₂₀ aryl group (substituted or unsubstituted); alternatively, a C₆-C₁₅ aryl group (substituted or unsubstituted); or alternatively, a C₆-C₁₀ aryl group (substituted or unsubstituted). In an embodiment, each R¹, R², R³, and/or R⁴ independently can be a phenyl group, a substituted phenyl group, a naphthyl group, or a substituted naphthyl group. In an embodiment, each R¹, R², R³, and/or R⁴ independently can be a phenyl group or a substituted phenyl group; alternatively, a naphthyl group or a substituted naphthyl group; alternatively, a phenyl group or a naphthyl group; or alternatively, a substituted phenyl group or a substituted naphthyl group.

In an embodiment, each substituted phenyl group which can be utilized as a non-hydrogen R¹, R², R³, and/or R⁴ independently can be a 2-substituted phenyl group, a 3-substituted phenyl group, a 4-substituted phenyl group, a 2,4-disubstituted phenyl group, a 2,6-disubstituted phenyl group, a 3,5-disubstituted phenyl group, or a 2,4,6-trisubstituted phenyl group. In other embodiments, each substituted phenyl group which can be utilized as a non-hydrogen R¹, R², R³, and/or R⁴ independently can be a 2-substituted phenyl group, a 4-substituted phenyl group, a 2,4-disubstituted phenyl group, or a 2,6-disubstituted phenyl group; alternatively, a 3-substituted phenyl group or a 3,5-disubstituted phenyl group; alternatively, a 2-substituted phenyl group or a 4-substituted phenyl group; alternatively, a 2,4-disubstituted phenyl group or a 2,6-disubstituted phenyl group; alternatively, a 2-substituted phenyl group; alternatively, a 3-substituted phenyl group; alternatively, a 4-substituted phenyl group; alternatively, a 2,4-disubstituted phenyl group; alternatively, a 2,6-disubstituted phenyl group; alternatively, 3,5-disubstituted phenyl group; or alternatively, a 2,4,6-trisubstituted phenyl group. Substituents for the substituted phenyl groups (general or specific) are independently disclosed herein and can be utilized without limitation to further describe the substituted phenyl groups which can be utilized as a non-hydrogen R¹, R², R³, and/or R⁴.

Nonlimiting examples of suitable poly(arylene sulfide) polymers suitable for use in this disclosure include poly(2,4-toluene sulfide), poly(4,4′-biphenylene sulfide), poly(para-phenylene sulfide), poly(ortho-phenylene sulfide), poly(meta-phenylene sulfide), poly(xylene sulfide), poly(ethylisopropylphenylene sulfide), poly(tetramethylphenylene sulfide), poly(butylcyclohexylphenylene sulfide), poly(hexyldodecylphenylene sulfide), poly(octadecyl-phenylene sulfide), poly(phenylphenylene sulfide), poly(tolylphenylene sulfide), poly(benzyl-phenylene sulfide), poly[octyl-4-(3-methylcyclopentyl)phenylene sulfide], and any combination thereof.

In an embodiment the poly(arylene sulfide) polymer comprises poly(phenylene sulfide) or PPS. In an aspect, PPS is a polymer comprising at least about 70, 80, 90, or 95 mole percent para-phenylene sulfide units. In another embodiment, the poly(arylene sulfide) can contain up to about 50, 70, 80, 90, 95, or 99 mole percent para-phenylene sulfide units. In some embodiments, PPS can contain from any minimum mole percent of the para-phenylene sulfide unit disclosed herein to any maximum mole percent of the para-phenylene sulfide unit disclosed herein; for example, from about 70 to about 99 mole percent, alternatively, from about 70 to about 95 mole percent, or alternatively, from about 80 to about 95 mole percent of the —(Ar—S)— unit. Other suitable ranges for the para-phenylene sulfide units will be readily apparent to one of skill in the art with the help of this disclosure. The structure for the para-phenylene sulfide unit can be represented by Formula II.

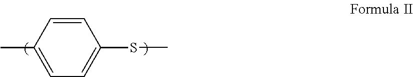

In an embodiment, PPS can comprise up to about 30, 20, 10, or 5 mole percent of one or more units selected from ortho-phenylene sulfide groups, meta-phenylene sulfide groups, substituted phenylene sulfide groups, phenylene sulfone groups, substituted phenylene sulfone groups, or groups having the following structures:

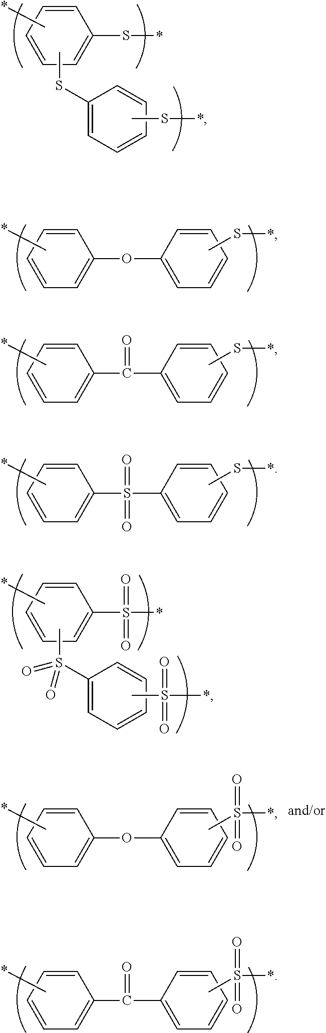

In other embodiments, PPS can comprise up to about 30, 20, 10, or 5 mole percent of units having one or more of the following structures:

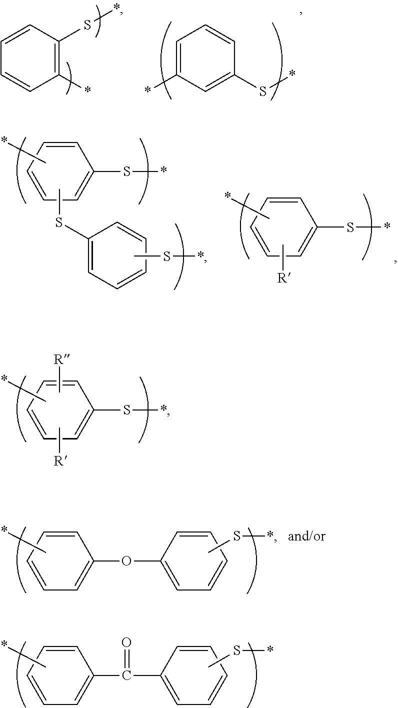

wherein R′ and R″ can be independently selected from any arylene substituent group disclosed herein for a poly(arylene sulfide). In other embodiments, PPS can comprise up to about 30, 20, 10, or 5 mole percent of units having one or more of the following structures:

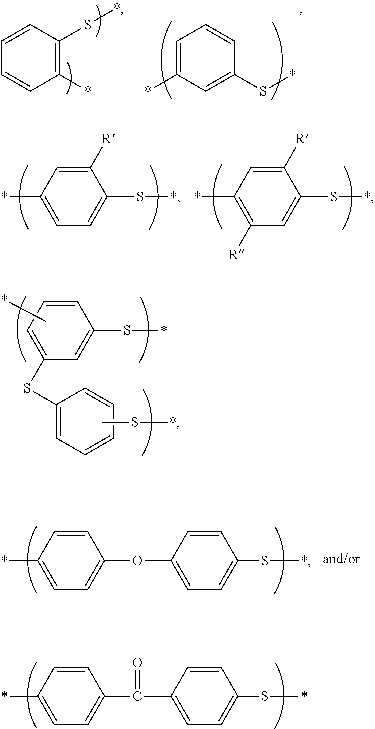

wherein R′ and R″ can be independently selected from any arylene substituent group disclosed herein for a poly(arylene sulfide). In other embodiments, PPS can comprise up to about 30, 20, 10, or 5 mole percent of units having one or more of the following structures:

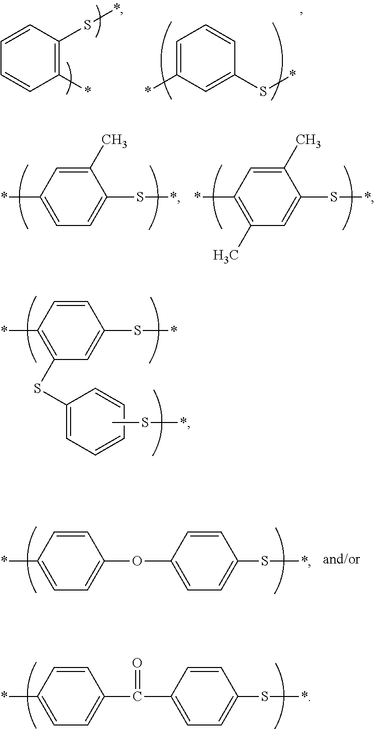

The PPS molecular structure can readily form a thermally stable crystalline lattice, giving PPS a semi-crystalline morphology with a high crystalline melting point ranging from about 265° C. to about 315° C. Because of its molecular structure, PPS also can tend to char during combustion, making the material inherently flame resistant. Further, PPS can not typically dissolve in solvents at temperatures below about 200° C.

PPS is manufactured and sold under the trade name Ryton® PPS by Chevron Phillips Chemical Company LP of The Woodlands, Tex. Other sources of poly(phenylene sulfide) include Ticona, Toray, and Dainippon Ink and Chemicals, Incorporated, among others.

In an embodiment, the process for producing a poly(arylene sulfide) polymer can comprise a step of polymerizing reactants in a reaction vessel or reactor to produce a reaction mixture (e.g., poly(arylene sulfide) reaction mixture). Generally, polymerizing reactants comprises reacting a sulfur source and a dihaloaromatic compound (e.g., a polymerization reaction) in the presence of a polar organic compound to form a reaction mixture (e.g., a polymerization reaction mixture).

In an embodiment, the process for producing a poly(arylene sulfide) polymer can be a continuous process, wherein all process steps can be conducted in a continuous manner. In an embodiment, the process for producing a poly(arylene sulfide) polymer can be a substantially continuous process, wherein at least some of the process steps (including polymerizing reactants in a reaction vessel) can be conducted in a continuous manner. In an embodiment, polymerizing reactants in a reaction vessel can be conducted in a continuous manner (as opposed to batch polymerization), wherein reactants can be introduced continuously to the reaction vessel to form the reaction mixture, and wherein a portion of the reaction mixture can be continuously removed from the reaction vessel to yield a reaction product mixture, as will be described in more detail later herein.

In an embodiment, the process for producing a poly(arylene sulfide) polymer comprises polymerizing reactants (e.g., a sulfur source and a dihaloaromatic compound) in a reaction vessel or reactor, to produce a reaction mixture (e.g., a poly(arylene sulfide) reaction mixture), wherein at least a portion of the reactants undergo a polymerization reaction.

Generally, a poly(arylene sulfide) can be produced by contacting at least one halogenated aromatic compound having two halogens, a sulfur source, and a polar organic compound to form the poly(arylene sulfide). In an embodiment, the process to produce the poly(arylene sulfide) can further comprise recovering the poly(arylene sulfide). In some embodiments, the polyarylene sulfide can be formed under polymerization conditions capable of producing the poly(arylene sulfide). In an embodiment, the poly(arylene sulfide) can be produced in the presence of a halogenated aromatic compound having greater than two halogen atoms (e.g., 1,2,4-trichlorobenzene, among others).

Similarly, PPS can be produced by contacting at least one para-dihalobenzene compound, a sulfur source, and a polar organic compound to form the PPS. In an embodiment, the process to produce the PPS can further comprise recovering the PPS. In some embodiments, the PPS can be formed under polymerization conditions capable of forming the PPS. When producing PPS, other dihaloaromatic compounds can also be present so long as the produced PPS conforms to the PPS desired features. For example, in an embodiment, the PPS can be prepared utilizing substituted para-dihalobenzene compounds and/or halogenated aromatic compounds having greater than two halogen atoms (e.g., 1,2,4-trichlorobenzene or a substituted 1,2,4-trichlorobenzene, among others).

In an embodiment, the process for producing a poly(arylene sulfide) polymer can comprise a step of contacting a sulfur compound and a polar organic compound to produce a sulfur complex mixture, wherein the sulfur complex mixture comprises a sulfur complex. In such embodiment, the sulfur source necessary for the polymerization reaction comprises the sulfur complex.

In an embodiment, the sulfur complex mixture can be prepared in a vessel upstream from the reaction vessel. In some embodiments, the sulfur complex mixture can be prepared continuously in a vessel upstream from the reaction vessel. In other embodiments, the sulfur complex mixture can be prepared in a batch or semibatch manner in a vessel upstream from the reaction vessel.

In some embodiments, the sulfur complex mixture can be introduced to the reaction vessel from the vessel in which such sulfur complex mixture was prepared in. In other embodiments, at least a portion of the sulfur complex mixture can be transferred to a storage vessel. In an embodiment, at least a portion of the sulfur complex mixture can be held in a storage vessel prior to a step of continuously introducing the sulfur complex mixture and at least one halogenated aromatic compound having two halogens to the reaction vessel.

In an embodiment, at least a portion of the sulfur complex mixture can be dehydrated prior to the step of continuously introducing the sulfur complex mixture and at least one halogenated aromatic compound having two halogens to the reaction vessel. In an embodiment, at least a portion of the sulfur complex mixture can be dehydrated to yield a dehydrated sulfur complex mixture. In some embodiments, the sulfur complex mixture can be continuously dehydrated prior to introducing to the reaction vessel. In an embodiment, at least a portion of the sulfur complex mixture can be dehydrated prior to, concurrent with, and/or subsequent to transferring the sulfur complex mixture to a storage vessel.

In an embodiment, at least a portion of the sulfur complex mixture can be dehydrated prior to transferring the sulfur complex mixture to a storage vessel. In some embodiments, the sulfur complex mixture can be dehydrated in a dehydrator located between the vessel in which the sulfur complex mixture is prepared and the storage vessel (e.g., downstream from the vessel in which the sulfur complex mixture is prepared and upstream from the storage vessel).

In an embodiment, at least a portion of the sulfur complex mixture can be dehydrated concurrent with transferring the sulfur complex mixture to a storage vessel. In such embodiment, the storage vessel can also dehydrate the sulfur complex mixture to yield a dehydrated sulfur complex mixture.

In an embodiment, the sulfur complex mixture can be dehydrated by contacting at least a portion of the sulfur complex mixture with a dessicant. Nonlimiting examples of dessicants suitable for use in the present disclosure include silica, activated charcoal, calcium sulfate, calcium chloride, molecular sieves (e.g., zeolites), and the like, or combinations thereof.

In an embodiment, the sulfur complex mixture can comprise a sulfur complex and a polar organic compound. As will be appreciated by one of skill in the art, and with the help of this disclosure, the sulfur complex mixture can also comprise some sulfur compound that did not react to form the sulfur complex.

Nonlimiting examples of sulfur compounds suitable for use in the present disclosure for the synthesis of the poly(arylene sulfide) include thiosulfates, thioureas, thioamides, elemental sulfur, thiocarbamates, metal disulfides, metal oxysulfides, thiocarbonates, organic mercaptans, organic mercaptides, organic sulfides, alkali metal sulfides, alkali metal bisulfides, lithium hydrosulfide, sodium hydrosulfide, potassium hydrosulfide, rubidium hydrosulfide, cesium hydrosulfide, hydrogen sulfide, and the like, or combinations thereof.

In an embodiment, an alkali metal sulfide can be used as the sulfur compound. Alkali metal sulfides suitable for use in the present disclosure can be, comprise, or consist essentially of, lithium sulfide, sodium sulfide, potassium sulfide, rubidium sulfide, cesium sulfide, and the like, or combinations thereof. In some embodiments, the alkali metal sulfides that can be employed in the synthesis of the poly(arylene sulfide) can be an alkali metal sulfide hydrate or an aqueous alkali metal sulfide solution; alternatively, an alkali metal sulfide hydrate; or alternatively, an aqueous alkali metal sulfide solution. Aqueous alkali metal sulfide solution can be prepared by any suitable methodology.

In an embodiment, the aqueous alkali metal sulfide solution can be prepared by the reaction of an alkali metal hydroxide with an alkali metal bisulfide in water; or alternatively, prepared by the reaction of an alkali metal hydroxide with hydrogen sulfide (H₂S) in water. Other sulfur sources suitable for use in the present disclosure are described in more detail in U.S. Pat. No. 3,919,177, which is incorporated by reference herein in its entirety.

In an embodiment, the sulfur complex mixture can further comprise an alkali metal hydroxide. In such embodiment, the step of contacting a sulfur compound and a polar organic compound can further comprise contacting therewith the alkali metal hydroxide. Nonlimiting examples of alkali metal hydroxides suitable for use in the present disclosure include lithium hydroxide, sodium hydroxide, potassium hydroxide, rubidium hydroxide, cesium hydroxide, and the like, or combinations thereof.

In an embodiment, a process for the preparation of poly(arylene sulfide) can utilize a sulfur compound which can be, comprise, or consist essentially of, an alkali metal bisulfide. In such embodiments, a reaction mixture for preparation of the poly(arylene sulfide) can comprise a base. In such embodiments, alkali metal hydroxides, such as sodium hydroxide (NaOH) can be utilized. In such embodiments, it can be desirable to reduce the alkalinity of the reaction mixture and/or reaction product mixture. Without wishing to be limited by theory, a reduction in alkalinity of the reaction mixture and/or reaction product mixture can result in the formation of a reduced amount of ash-causing polymer structures. The alkalinity of the reaction mixture and/or reaction product mixture can be reduced by any suitable methodology, for example by the addition of an acidic solution.

In an embodiment, the sulfur compound suitable for use in the production of poly(arylene sulfide) can be prepared by combining sodium hydrosulfide (NaSH) and sodium hydroxide (NaOH) in an aqueous solution followed by dehydration (or alternatively, by combining an alkali metal hydroxide with hydrogen sulfide (H₂S)). The production of Na₂S in this manner can be considered to be an equilibrium between Na₂S, water (H₂O), NaSH, and NaOH according to the following equation.

Na₂S+H₂O⇄NaSH+NaOH

The resulting sulfur compound can be referred to as sodium sulfide (Na₂S). In another embodiment, the production of Na₂S can be performed in the presence of the polar organic solvent, e.g., N-methyl-2-pyrrolidone (NMP), among others disclosed herein. Without wishing to be limited by theory, when the sulfur compound (e.g., sodium sulfide) is prepared by reacting NaSH with NaOH in the presence of water and N-methyl-2-pyrrolidone, the N-methyl-2-pyrrolidone can also react with the sodium hydroxide (e.g., aqueous sodium hydroxide) to produce a mixture containing sodium hydrosulfide and sodium N-methyl-4-aminobutanoate (SMAB). Stoichiometrically, the overall reaction equilibrium can appear to follow the equation:

NMP+Na₂S+H₂O⇄CH₃NHCH₂CH₂CH₂CO₂Na(SMAB)+NaSH

However, it should be noted that this equation is a simplification and, in actuality, the equilibrium between Na₂S, H₂O, NaOH, and NaSH, and the water-mediated ring opening of NMP by sodium hydroxide can be significantly more complex.

In an embodiment, the sulfur complex can comprise sodium N-methyl-4-aminobutanoate (SMAB), alkali metal carboxylates, lithium benzoate, sodium benzoate, potassium benzoate, rubidium benzoate, cesium benzoate, lithium acetate, sodium acetate, potassium acetate, rubidium acetate, cesium acetate, poly(arylene sulfide) oligomers, poly(phenylene sulfide) oligomers, thio-N-methyl-2-pyrrolidone, and the like, or combinations thereof. Sulfur sources are described in more detail in U.S. Pat. No. 3,919,177, which is incorporated by reference herein in its entirety.

In an alternative embodiment, a feedstock (e.g., supplemental feedstock) for the reaction vessel can comprise poly(arylene sulfide) oligomers recovered from the reaction product mixture. In such embodiment, the oligomers could be recovered following a quench type recovery of the poly(arylene sulfide) polymer and/or washing the poly(arylene sulfide) polymer with NMP.

The polar organic compound which can be utilized in the preparation of a poly(arylene sulfide) can comprise a polar organic compound which can function to keep the dihaloaromatic compounds, sulfur complex, and growing poly(arylene sulfide) in solution during the polymerization. In an aspect, the polar organic compound can be, comprise, or consist essentially of, an amide, a lactam, a sulfone, or any combinations thereof; alternatively, an amide; alternatively, a lactam; or alternatively, a sulfone. In an embodiment, the polar organic compound can be, comprise, or consist essentially of, hexamethylphosphoramide, tetramethylurea, N,N-ethylenedipyrrolidone, N-methyl-2-pyrrolidone, pyrrolidone, caprolactam, N-ethylcaprolactam, sulfolane, N,N′-dimethylacetamide, 1,3-dimethyl-2-imidazolidinone, low molecular weight polyamides, or combinations thereof. In an embodiment, the polar organic compound can be, comprise, or consist essentially of, N-methyl-2-pyrrolidone. Additional polar organic compounds suitable for use in the present disclosure are described in more detail in D. R. Fahey and J. F. Geibel, Polymeric Materials Encyclopedia, Vol. 8, (Boca Raton, CRC Press, 1996), pages 6506-6515, which is incorporated by reference herein in its entirety.

In an embodiment, processes for the preparation of a poly(arylene sulfide) can employ one or more additional reagents. For example, molecular weight modifying or enhancing agents such as alkali metal carboxylates, lithium halides, or water can be added or produced during polymerization. In an embodiment, a reaction mixture for preparation of a poly(arylene sulfide) can further comprise an alkali metal carboxylate.

In an embodiment, the sulfur complex mixture can further comprise a molecular weight modifying agent. In such embodiment, the step of contacting a sulfur compound and a polar organic compound can further comprise contacting therewith the molecular weight modifying agent. Nonlimiting examples of molecular weight modifying agents suitable for use in the present disclosure include alkali metal carboxylates, sodium acetate, carboxylic acids, acetic acid, carboxylic anhydrides, acetic anhydride, lithium halides, water, and the like, or combinations thereof.

Alkali metal carboxylates which can be employed include, without limitation, those having general formula R′CO₂M where R′ can be a C₁ to C₂₀ hydrocarbyl group, a C₁ to C₂₀ hydrocarbyl group, or a C₁ to C₅ hydrocarbyl group. In some embodiments, R′ can be an alkyl group, a cycloalkyl group, an aryl group, aralkyl group; or alternatively, an alkyl group. Alkyl groups, cycloalkyl groups, aryl groups, aralkyl groups are disclosed herein (e.g., as options for R¹, R², R³, and R⁴ or a substituent groups). These alkyl groups, cycloalkyl groups, aryl groups, aralkyl groups can be utilized without limitation to further describe R′ of the alkali metal carboxylates having the formula R′CO₂M. In an embodiment, M can be an alkali metal. In some embodiments, the alkali metal can be, comprise, or consist essentially of, lithium, sodium, potassium, rubidium, or cesium; alternatively, lithium; alternatively, sodium; or alternatively, potassium. The alkali metal carboxylate can be employed as a hydrate; or alternatively, as a solution or dispersion in water. In an embodiment, the alkali metal carboxylate can be, comprise, or consist essentially of, sodium acetate (NaOAc or NaC₂H₃O₂).

In an alternative embodiment, the molecular modifying agent could be introduced directly to the reaction vessel (as opposed to being introduced to the reaction vessel as part of the sulfur complex mixture).

In an embodiment, the process for producing a poly(arylene sulfide) polymer can comprise a step of continuously introducing at least a portion of the sulfur complex mixture and at least one halogenated aromatic compound having two halogens to a reaction vessel to form a reaction mixture, wherein the reaction vessel can be continuously stirred, and wherein the reaction vessel can comprise a single reaction zone.

In an embodiment, halogenated aromatic compounds having two halogens (e.g., dihaloaromatic compounds) which can be employed to produce the poly(arylene sulfide) can be represented by Formula III.

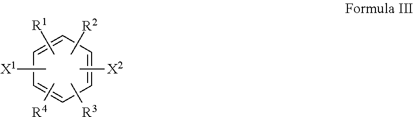

In an embodiment, X¹ and X² independently can be a halogen. In some embodiments, each X¹ and X² independently can be fluorine, chlorine, bromine, iodine; alternatively, chlorine, bromine, or iodine; alternatively, chlorine; alternatively, bromine; or alternatively, iodine. R¹, R², R³ and R⁴ have been described previously herein for the poly(arylene sulfide) having Formula I. Any aspect and/or embodiment of these R¹, R², R³, and R⁴ descriptions can be utilized without limitation to describe the halogenated aromatic compounds having two halogens represented by Formula III. It should be understood, that for producing poly(arylene sulfide), the relationship between the position of the halogens X¹ and X² can be ortho, meta, para, or any combination thereof; alternatively, ortho; alternatively, meta; or alternatively, para. Examples of halogenated aromatic compounds having two halogens that can be utilized to produce a poly(arylene sulfide) can include, but are not limited to, dichlorobenzene (ortho, meta, and/or para), dibromobenzene (ortho, meta, and/or para), diiodobenzene (ortho, meta, and/or para), chlorobromobenzene (ortho, meta, and/or para), chloroiodobenzene (ortho, meta, and/or para), bromoiodobenzene (ortho, meta, and/or para), dichlorotoluene, dichloroxylene, ethylisopropyldibromobenzene, tetramethyldichlorobenzene, butylcyclohexyldibromobenzene, hexyldodecyldichlorobenzene, octadecyldiidobenzene, phenylchlorobromobenzene, tolyldibromobenzene, benzyldichloro-benzene, octylmethylcyclopentyldichlorobenzene, or any combination thereof.

The para-dihalobenzene compound which can be utilized to produce poly(phenylene sulfide) can be any para-dihalobenzene compound. In an embodiment, para-dihalobenzenes that can be used in the synthesis of PPS can be, comprise, or consist essentially of, p-dichlorobenzene, p-dibromobenzene, p-diiodobenzene, 1-chloro-4-bromobenzene, 1-chloro-4-iodobenzene, 1-bromo-4-iodobenzene, or any combination thereof. In some embodiments, the para-dihalobenzene that can be used in the synthesis of PPS can be, comprise, or consist essentially of, p-dichlorobenzene.

In some embodiments, the synthesis of the PPS can further include 2,5-dichlorotoluene, 2,5-dichloro-p-xylene, 1-ethyl-4-isopropyl-2,5-dibromobenzene, 1,2,4,5-tetramethyl-3,6-dichlorobenzene, 1-butyl-4-cyclohexyl-2,5-dibromobenzene, 1-hexyl-3-dodecyl-2,5-dichlorobenzene, 1-octadecyl-2,5-diidobenzene, 1-phenyl-2-chloro-5-bromobenzene, 1-(p-tolyl)-2,5-dibromobenzene, 1-benzyl-2,5-dichlorobenzene, 1-octyl-4-(3-methylcyclopentyl)-2,5-dichlorobenzene, or combinations thereof.

Generally, the ratio of reactants employed in the polymerization process to produce a poly(arylene sulfide) can vary widely. However, the typical molar equivalent ratio of the halogenated aromatic compound having two halogens to sulfur compound can be in the range of from about 0.8 to about 2; alternatively, from about 0.9 to about 1.5; or alternatively, from about 0.95 to about 1.3. The amount of polyhalo-substituted aromatic compound (e.g., trihaloaromatic compound) optionally employed as a reactant can be any amount to achieve a desired degree of branching to give a desired poly(arylene sulfide) melt flow. Generally, up to about 0.02 moles of polyhalo-substituted aromatic compound per mole of halogenated aromatic compound having two halogens can be employed. As will be appreciated by one of skill in the art, and with the help of this disclosure, generally, the flow properties of a polymer (e.g., melt flow, flow rate, etc.) correlate with the degree of branching (e.g., the use of a polyhalo-substituted aromatic compound could cause branching and lower the flow rate). If an alkali metal carboxylate is employed as a molecular weight modifying agent, the mole ratio of alkali metal carboxylate to dihaloaromatic compound(s) can be within the range of from about 0.02 to about 4; alternatively, from about 0.05 to about 3; or alternatively, from about 0.1 to about 2.

The amount of polar organic compound employed in the process to prepare the poly(arylene sulfide) can vary over a wide range during the polymerization. However, the molar ratio of polar organic compound to the sulfur compound can typically be within the range of from about 1 to about 10. If a base, such as sodium hydroxide, is employed, the molar ratio can generally be in the range of from about 0.5 to about 4 moles per mole of sulfur compound.

In an embodiment, the reaction vessel can have any suitable geometry. In some embodiments, the reaction vessel can have a cylindrical or tubular geometry, wherein the reaction vessel can have a reaction vessel body (e.g., a cylindrical reaction vessel body). Generally, the reaction vessel can have an upright cylindrical geometry. The reaction vessel body can be characterized with respect to a reaction vessel body central axis. In some embodiments, the reaction vessel body central axis can be vertical (e.g., perpendicular to a surface on which the reactor vessel rests on).

In an embodiment, the reaction vessel can be continuously stirred or agitated by using any suitable agitation means. In an embodiment, the reaction vessel can be continuously stirred by a rotary agitator; by a magnetic stirrer; by bubbling or sparging an inert gas through a liquid phase (e.g., reaction mixture) inside the reaction vessel; and the like, or combinations thereof. In an embodiment, the reaction vessel can comprise baffles, wherein the baffles aid the mixing of the reaction mixture.

In an embodiment, the rotary agitator can comprise an agitator shaft and one or more stirring tools, wherein the stirring tools can be attached to the agitator shaft, and wherein the agitator shaft can rotate within the reaction vessel, thereby causing the stirring tools to rotate and thoroughly mix the reaction mixture. In an embodiment, the agitator shaft can be characterized with respect to a central or vertical shaft axis. In an embodiment, the agitator shaft can comprise a rod, a hollow pipe, or combinations thereof. The reaction vessel body can be coaxially aligned with the agitator shaft, e.g., the central shaft axis can coincide with the reaction vessel body central axis. In an embodiment, the agitator tools can comprise paddles, blades, stifling blades, helices, propellers, impellers, and the like, or combinations thereof.

In an embodiment, the reaction mixture inside the reaction vessel can be very well mixed, so the reaction mixture can have relatively uniform properties (e.g., temperature, density, concentration, etc.) throughout.

In an embodiment, the reaction vessel can comprise a single continuous stirred tank reactor. Generally, continuous stirred tank reactors (CSTRs) are open systems (as opposed to closed systems for batch reactors), wherein material is free to enter (e.g., reactants) or exit (e.g., products) the system. CSTRs typically operate on a steady-state basis, wherein once steady state is reached, the conditions in the reactor do not change with time. Reactants can be continuously introduced into the reactor, while products can be continuously removed.

In an embodiment, the reaction vessel excludes a stirred tank cascade. Generally, a stirred tank cascade comprises two or more CSTRs operated in series (e.g., sequentially), wherein an effluent from a first CSTR can be introduced as a reactant in a second CSTR; an effluent from a second CSTR can be introduced as a reactant in a third CSTR; etc.

In an embodiment, the reaction vessel excludes a flow tube reactor. Generally, a flow tube reactor, also known as a plug flow reactor, comprises a fluid (e.g., a reaction mixture) flowing through the flow tube reactor as a series of infinitely thin coherent “plugs,” each plug having an uniform composition, traveling in the axial direction of the flow tube reactor, with each plug having a different composition from the ones before and after it. In flow tube reactors it is assumed that as a plug flows through a flow tube reactor, the fluid is perfectly mixed in the radial direction, but not in the axial direction (forwards or backwards). As will be appreciated by one of skill in the art, and with the help of this disclosure, each plug can be characterized by a reaction volume, wherein a defined set of reactions take place as the plug moves along the flow tube reactor, and as such the flow tube reactor is characterized by multiple reaction volumes. Further, as will be appreciated by one of skill in the art, and with the help of this disclosure, each plug represents its own reaction zone, and as such the flow tube reactor inherently contains multiple reaction zones.

In an embodiment, the reaction vessel can comprise a single reaction zone (as opposed to multiple reaction zones, as found in a CSTR cascade or a flow tube reactor, for example). As will be appreciated by one of skill in the art, and with the help of this disclosure, the reaction mixture inside the reaction vessel can be very well mixed, and as a result, the composition of the reaction mixture is uniform or substantially uniform throughout the reaction vessel, thereby yielding a single reaction zone.

In an embodiment, the reaction vessel can comprise a single continuous reaction volume (as opposed to multiple reaction volumes, as found in a flow tube reactor, for example). As will be appreciated by one of skill in the art, and with the help of this disclosure, the reaction mixture inside the reaction vessel can be very well mixed, and as a result, the composition of the reaction mixture is uniform or substantially uniform throughout the reaction vessel, thereby yielding a single continuous reaction volume.

In an embodiment, the reaction vessel excludes reactor partitions, wherein reactor partitions define two or more reaction zones. As will be appreciated by one of skill in the art, and with the help of this disclosure, any partition present in a reactor could impede the mixing of the reaction mixture, to the extent that the composition of the reaction mixture would not be uniform or substantially uniform throughout the reaction vessel, thereby creating two or more reaction zones within the vessel.

In an embodiment, the reaction vessel can be equipped with one or more reactor inlets and one or more reactor outlets. The reactor inlets can serve to continuously introduce the sulfur complex mixture, halogenated aromatic compound, etc., to the reaction vessel. The reactor outlets can serve to continuously remove a portion of the reaction mixture from the reaction vessel to yield a reaction product mixture.

General conditions for the production of poly(arylene sulfides) are generally described in U.S. Pat. Nos. 5,023,315; 5,245,000; 5,438,115; and 5,929,203; each of which is incorporated by reference herein in its entirety.

In an embodiment, any reactants introduced to the reaction vessel can be dehydrated prior to introducing such reactants to the reaction vessel. For example, in instances where a significant amount of water is present (e.g., more than about 0.3 moles of water per mole of sulfur compound) in any of the reactants, water can be removed in a dehydration process.

In an embodiment, the reaction vessel can be heated to a temperature of from about 180° C. (356° F.) to about 290° C. (554° F.), alternatively from about 200° C. (392° F.) to about 285° C. (545° F.), or alternatively from about 204° C. (400° F.) to about 282° C. (540° F.).

In an embodiment, the reaction vessel can be heated by any suitable means, such as for example external heating; external heating using a jacket; internal heating; coil heating; heating internal elements of the reaction vessel wherein the internal elements can comprise a shaft (e.g., an agitator shaft) and/or a stifling tool; looping or pumping the reaction mixture through an external heat exchanger; and the like; or combinations thereof. As will be appreciated by one of skill in the art, and with the help of this disclosure, the means for heating the reaction vessel can also be used for removing heat from the reaction vessel.

The reactor pressure need be only sufficient to maintain the polymerization reaction mixture substantially in the liquid phase. In an embodiment, the reaction vessel can have a pressure of from about 0 psig to about 400 psig; alternatively from about 30 psig to about 300 psig; or alternatively from about 100 psig to about 250 psig.

In an embodiment, the process for producing a poly(arylene sulfide) polymer can comprise a step of continuously removing a portion of the reaction mixture from the reaction vessel to yield a reaction product mixture. In such embodiment, the reaction mixture can be continuously removed through a reactor outlet. In some embodiments, at least a portion of the reaction product mixture could be processed as exiting the reaction vessel. In other embodiments, at least a portion of the reaction product mixture could be transferred to a storage container prior to a step of processing the reaction product mixture.

In an embodiment, the process for producing a poly(arylene sulfide) polymer can comprise a step of processing at least a portion of the reaction product mixture to obtain a poly(arylene sulfide) polymer, wherein the poly(arylene sulfide) polymer can be the product of a single stage polymerization. In such embodiment, processing the reaction product mixture can comprise continuously forming poly(arylene sulfide) polymer particles.

In an embodiment, continuously forming poly(arylene sulfide) polymer particles can comprise terminating the polymerization reaction. In an embodiment, continuously forming poly(arylene sulfide) polymer particles can comprise cooling at least a portion of the reaction product mixture to a temperature of less than about 180° C. The polymerization can be terminated by cooling the reaction product mixture (removing heat) to a temperature below that at which substantial polymerization takes place. In some instances the cooling of the reaction mixture also can begin the process to recover the poly(arylene sulfide) as the poly(arylene sulfide) can precipitate from solution at temperatures less than about 180° C. Depending upon the polymerization features (temperature, solvent(s), and water quantity, among other features) and the methods employed to cool the reaction mixture, the poly(arylene sulfide) can begin to precipitate from the reaction solution at a temperature ranging from about 200° C. to about 180° C. Generally, poly(arylene sulfide) precipitation can impede further polymerization. It should be noted that termination of the polymerization does not imply that complete reaction of the polymerization components has occurred. Moreover, termination of the polymerization is not meant to imply that no further polymerization of the reactants can take place. The reaction product mixture can be cooled using a variety of methods, such as for example by quenching the reaction product mixture or by flash evaporating a portion of the solvent from the reaction product mixture.

In an embodiment, continuously forming poly(arylene sulfide) polymer particles can comprise quenching at least a portion of the reaction product mixture by adding a quench liquid thereto to form a quenched mixture, wherein the quenched mixture can comprise poly(arylene sulfide) polymer particles.

In some embodiments, the polymerization can be terminated by adding a liquid (e.g., a quench liquid) comprising, consisting essentially of, or consisting of 1) water, 2) polar organic compound, or 3) a combination of water and polar organic compound (alternatively water; or alternatively, polar organic compound) to the reaction product mixture and cooling the reaction product mixture. In other embodiments, the polymerization can be terminated by adding quench liquid comprising a solvent(s) other than water or the polar organic compound to the reaction product mixture and cooling the reaction product mixture. Processes for preparing poly(arylene sulfide) which utilize the addition of water, polar organic compound, and/or other solvent(s) to terminate the reaction can be referred to as a quench termination process. The cooling of the reaction product mixture can be facilitated by the use of cooling jackets or coils. In yet other embodiments, terminating the polymerization can include contacting the reaction product mixture with a quench liquid comprising a polymerization inhibiting compound. In still yet other embodiments, a long slow cooling heat exchanger could be used, wherein the long slow cooling heat exchanger could also comprise a disengagement space for polymer particles as they form, and wherein the long slow cooling exchanger could allow for continuous processing while cooling the mixture at a slow cooling rate.

Once the poly(arylene sulfide) has precipitated from solution (e.g., reaction product mixture, quenched mixture), a particulate poly(arylene sulfide) can be separated (e.g., recovered, retrieved, obtained, etc.) from the quenched mixture by any process capable of separating a solid precipitate from a liquid (e.g., filtration, centrifugation, screening, sieving, etc.).

In an embodiment, a process for producing a poly(arylene sulfide) polymer can further comprise a step of contacting (e.g., washing) the particulate poly(arylene sulfide) with a polar organic compound and/or water to obtain a poly(arylene sulfide) polymer. The particulate poly(arylene sulfide) can be repeatedly washed by using screens or sieves, such as for example shaker screens. In an embodiment, a washing vessel can receive the quenched mixture (e.g., the quenched mixture can be introduced to a washing vessel), wherein the particulate poly(arylene sulfide) can be retained on a screen and can be further washed with a polar organic compound and/or water. As will be appreciated by one of skill in the art, more than one washing vessel can be used for washing the particulate poly(arylene sulfide), such as for example two, three, four, five, six, or more washing vessels can be used for washing the particulate poly(arylene sulfide).

In an embodiment, continuously forming poly(arylene sulfide) polymer particles can comprise flashing at least a portion of the reaction product mixture to form a flashed mixture, wherein the flashed mixture can comprise poly(arylene sulfide) polymer particles.

In an embodiment, continuously forming poly(arylene sulfide) polymer particles can comprise operating at least two flash units in parallel. In such embodiment, a flash unit can remove at least a portion of a liquid phase of the reaction product mixture from at least a portion of the reaction product mixture to form a flashed poly(arylene sulfide) polymer mixture, wherein the flashed poly(arylene sulfide) polymer mixture can comprise poly(arylene sulfide) polymer particles. As will be appreciated by one of skill in the art, and with the help of this disclosure, a flash unit generally operates as a batch process, and as such at least two flash units operated in parallel are required to provide for a continuous process. Further, as will be appreciated by one of skill in the art, and with the help of this disclosure, when at least two flash units are operated in parallel, at least one flash unit would be available to receive the reaction product mixture, and the output from the flash units could ensure a continuous process downstream the flash units.

In an embodiment, a first flash unit (e.g., a flash blender) can flash (e.g., remove at least a portion of a liquid phase) at least a portion of the reaction product mixture to form a flashed poly(arylene sulfide) polymer mixture, and the flashed poly(arylene sulfide) polymer mixture can be further dried in the first flash unit. While the first flash unit is drying the flashed poly(arylene sulfide) polymer mixture, a second flash unit can receive at least a portion of the reaction product mixture, thereby ensuring a continuous process downstream the flash units.

In an embodiment, the at least two flash units can be located downstream the reaction vessel. In an embodiment, the at least two flash units can provide a continuous supply of a flashed poly(arylene sulfide) polymer mixture comprising poly(arylene sulfide) polymer particles. In some embodiments, the flashed poly(arylene sulfide) polymer mixture from each flash unit can be collected into a common container, and the common container can supply continuously the flashed poly(arylene sulfide) polymer mixture for the remaining steps in process of producing the poly(arylene sulfide) polymer.

In an embodiment, the polymerization can be terminated by the flash evaporation of the solvent (e.g., the polar organic compound, water, or a combination thereof) from the reaction product mixture. Processes for preparing poly(arylene sulfide) utilizing solvent flash evaporation to terminate the reaction can be referred to as a flash termination process.

In an embodiment, the reaction product mixture can be introduced to a flash unit (e.g., a flash blender), wherein the solvent of the reaction product mixture can be removed or evaporated to yield the flashed poly(arylene sulfide) polymer mixture comprising poly(arylene sulfide) polymer particles. In some embodiments, steam can be introduced to the flash unit along with the reaction product mixture to assist the evaporation process. Generally the solvent and the steam leave the flash unit at the top (overhead), leaving a solid flashed poly(arylene sulfide) polymer mixture at the bottom of the flash unit.

In some embodiments, flashing at least a portion of the reaction product mixture to form a flashed mixture can be continuous or semi-continuous. In such embodiments, the reaction product mixture can be introduced to a continuous flashing system (e.g., a flash blender type piece of equipment that can operate in a plug flow fashion; a continuous spray dryer; etc.) to yield the flashed poly(arylene sulfide) polymer mixture comprising poly(arylene sulfide) polymer particles.

It should be noted that the polymerization process to produce the poly(arylene sulfide) can form a by-product alkali metal halide. The by-product alkali metal halide can be removed during process steps utilized to separate the poly(arylene sulfide) polymer particles, whether the continuously forming poly(arylene sulfide) polymer particles is done by a quench process or by a flash process.

For example, procedures which can be utilized to separate the poly(arylene sulfide) polymer particles from the quenched mixture slurry can include, but are not limited to, i) filtration; ii) washing the poly(arylene sulfide) polymer particles with a liquid (e.g., water or aqueous solution); or iii) dilution of the quenched mixture with liquid (e.g., water or aqueous solution) followed by filtration and washing the poly(arylene sulfide) polymer particles with a liquid (e.g., water or aqueous solution). For example, in a non-limiting embodiment, the quenched mixture slurry can be filtered to separate the poly(arylene sulfide) polymer particles (containing poly(arylene sulfide) or PPS, and by-product alkali metal halide), which can be slurried in a liquid (e.g., water or aqueous solution) and subsequently filtered to remove the alkali metal halide by-product (and/or other liquid, e.g., water, soluble impurities).

In an embodiment, the flashed poly(arylene sulfide) polymer mixture can comprise poly(arylene sulfide) polymer particles and an alkali metal halide by-product. For example, procedures which can be utilized to separate the poly(arylene sulfide) polymer particles from the flashed poly(arylene sulfide) polymer mixture can include, but are not limited to, i) slurrying the flashed poly(arylene sulfide) polymer mixture in a liquid (e.g., water or aqueous solution) followed by filtration and washing the poly(arylene sulfide) polymer particles with a liquid (e.g., water or aqueous solution); or ii) placing the flashed poly(arylene sulfide) polymer mixture on a filter or a series of filters and washing the flashed poly(arylene sulfide) polymer mixture with a liquid (e.g., water or aqueous solution) until the alkali metal halide by-product is removed and the poly(arylene sulfide) polymer is recovered.

Generally, any steps of washing and/or slurrying the poly(arylene sulfide) polymer particles and/or the flashed poly(arylene sulfide) polymer mixture with a liquid followed as appropriate by filtration to separate the poly(arylene sulfide) polymer particles can occur as many times as necessary to obtain a desired level of purity of the poly(arylene sulfide) polymer.

In an embodiment, the poly(arylene sulfide) polymer can be recovered by way of a screening process, wherein the poly(arylene sulfide) polymer can be retained on a screen (e.g., sieve, mesh, wire screen, wire sieve, wire mesh, etc.).

For purposes of the disclosure herein, the recovered particulate poly(arylene sulfide) will be referred to as “poly(arylene sulfide) polymer particles,” “poly(arylene sulfide) particles,” “particulate poly(arylene sulfide) polymer,” “particulate poly(arylene sulfide),” “poly(arylene sulfide) polymer,” or simply “poly(arylene sulfide),” irrespective of whether the particles were formed during a quench step or during a flash step. For purposes of the disclosure herein, poly(arylene sulfide) polymer particles can also be referred to as “raw particulate poly(arylene sulfide) polymer,” “raw particulate poly(arylene sulfide),” “raw poly(arylene sulfide) polymer particles,” “raw poly(arylene sulfide) particles,” “raw poly(arylene sulfide) polymer,” or simply “raw poly(arylene sulfide),” (e.g., “raw PPS”) where further processing steps are contemplated after recovery of the polymer particles.

In an embodiment, the poly(arylene sulfide) polymer can be the product of a single stage polymerization. For purposes of the disclosure herein, “single stage polymerization” refers to the polymerization occurring in a single reaction vessel, as opposed to, for example, a first polymer being removed from a first reaction vessel, and then introducing the first polymer to a second reaction vessel to further polymerize (e.g., increase molecular weight) the first polymer to yield the second polymer, wherein a molecular weight of the second polymer is greater than a molecular weight of the first polymer. When a polymer is being produced by two or more stages of polymerization, wherein a first polymer is the result of a first stage polymerization in a first reaction vessel, wherein the first polymer is further polymerized to yield a second polymer during a second stage polymerization in a second reaction vessel, and wherein a molecular weight of the second polymer is greater than a molecular weight of the second polymer, the first polymer can be referred to as a “prepolymer” and the first stage polymerization can be referred to as a “prepolymerization stage.” In an embodiment, the single stage polymerization excludes a prepolymerization stage. In an embodiment, the single stage polymerization excludes obtaining a first poly(arylene sulfide) polymer having a first molecular weight and subsequently polymerizing the first poly(arylene sulfide) polymer to yield a second poly(arylene sulfide) polymer having a second molecular weight, wherein the second molecular weight is greater than the first molecular weight.

In an embodiment, a molecular weight of the poly(arylene sulfide) polymer disclosed herein is not increased in a subsequent polymerization reaction (e.g., a second stage polymerization). As will be appreciated by one of skill in the art, and with the help of this disclosure, a second stage polymerization generally involves contacting the polymer or prepolymer with a sulfur compound and/or a sulfur complex mixture in order to provide for a longer polymeric chain, and therefore an increased molecular weight. In an embodiment, the poly(arylene sulfide) polymer disclosed herein is not further contacted with a sulfur compound and/or a sulfur complex mixture.

In an embodiment, the poly(arylene sulfide) polymer disclosed herein is not further slurried in a polar organic compound and heated to a temperature of greater than about 200° C. Generally, poly(arylene sulfide) polymers can not dissolve in solvents at temperatures below about 200° C., and the polymerization reaction that yields poly(arylene sulfide) polymers requires that the polymerizing molecules be dissolved in the solvent used for the polymerization reaction.

In an embodiment, the poly(arylene sulfide) polymer can be characterized by an weight average molecular weight (Mₙ) of from about 15,000 g/mol to about 60,000 g/mol, alternatively from about 20,000 g/mol to about 55,000 g/mol, alternatively from about 25,000 g/mol to about 50,000 g/mol, or alternatively from about 30,000 g/mol to about 45,000 g/mol; and a number average molecular weight (Mₙ) of from about 10,000 g/mol to about 60,000 g/mol, alternatively from about 15,000 g/mol to about 60,000 g/mol, alternatively from about 20,000 g/mol to about 60,000 g/mol, alternatively from about 25,000 g/mol to about 55,000 g/mol, or alternatively from about 30,000 g/mol to about 50,000 g/mol. The weight average molecular weight describes the size average of a polymer composition and can be calculated according to equation 1:

$${M}_{w} = \frac{{\sum }_{i} {N}_{i} {M}_{i}^{2}}{{\sum }_{i} {N}_{i} {M}_{i}} \qquad ( 1 )$$

wherein Nᵢ is the number of molecules of molecular weight Mᵢ. All molecular weight averages are expressed in gram per mole (g/mol) or Daltons (Da). The number average molecular weight is the common average of the molecular weights of the individual polymers calculated by measuring the molecular weight Mᵢ of Nᵢ polymer molecules, summing the weights, and dividing by the total number of polymer molecules, according to equation 2:

$${M}_{n} = \frac{{\sum }_{i} {N}_{i} {M}_{i}}{{\sum }_{i} {N}_{i}} \qquad ( 2 )$$

In an embodiment, the poly(arylene sulfide) polymer can be characterized by a molecular weight distribution (MWD) of from about 1,000 to about 90,000, alternatively from about 5,000 to about 80,000, or alternatively from about 10,000 to about 70,000. The MWD is the ratio of the M_{w} to the Mₙ (M_{w}/Mₙ), which can also be referred to as the polydispersity index (PDI) or more simply as polydispersity.

As will be appreciated by one of skill in the art, and with the help of this disclosure, the polymers obtained by continuous polymerization processes have a wider MWD than otherwise similar polymers obtained by batch polymerization processes. Generally, in batch polymerization processes, the forming polymers have the same residence time (e.g., the time a polymer molecule resides in the reactor) in the reactor. Without wishing to be limited by theory, in a continuous reactor, the residence time for a polymer molecule can vary from 0 seconds to infinity, and therefore the MWD of the recovered polymer can be very broad (e.g., can have very large values).

In an embodiment, the poly(arylene sulfide) polymer can be characterized by a flow rate under a force of 5 kg of from about 1 gram per 10 minutes (g/10 min) to about 3,000 g/10 min, alternatively from about 10 g/10 min to about 2,000 g/10 min, or alternatively from about 30 g/10 min to about 1,500 g/10 min. The flow rate refers to the amount of a polymer which can be forced through a melt indexer orifice of 0.0825 inch diameter when subjected to an indicated force (e.g., 5 kg) in ten minutes at 190° C., as determined in accordance with ASTM D1238. The flow rate can also be referred to as “melt flow rate” and/or “melt index.”

In an embodiment, a process for producing a poly(arylene sulfide) polymer can optionally comprise a step of treating at least a portion of the poly(arylene sulfide) polymer (e.g., poly(arylene sulfide) polymer particles) with an aqueous acid solution and/or an aqueous metal cation solution to obtain a treated poly(arylene sulfide) polymer, wherein the treated poly(arylene sulfide) polymer can be recovered from a treatment solution via a separation (e.g., filtration) step.

In an embodiment, the poly(arylene sulfide) polymer can be treated with an aqueous acid solution and/or can be treated with an aqueous metal cation solution, to yield treated poly(arylene sulfide) (e.g., acid treated poly(arylene sulfide), metal cation treated poly(arylene sulfide)). Additionally, the poly(arylene sulfide) polymer can be dried to remove liquid adhering to the poly(arylene sulfide) polymer particles. Generally, the poly(arylene sulfide) polymer which can be treated can be i) the poly(arylene sulfide) polymer particles separated from the reaction mixture or ii) the poly(arylene sulfide) polymer particles which have been washed with a liquid (e.g., water) and filtered to remove the alkali metal halide by-product (and/or other liquid soluble impurities). The poly(arylene sulfide) polymer particles which can be treated can either be liquid-wet or dry; alternatively, liquid-wet; or alternatively, dry.

Acid treatment can comprise a) contacting the poly(arylene sulfide) with water to form a poly(arylene sulfide) slurry, b) contacting the poly(arylene sulfide) slurry with an acidic compound to form an acidic mixture, c) heating the acidic mixture in the substantial absence of a gaseous oxidizing atmosphere to an elevated temperature below the melting point of the poly(arylene sulfide), and d) recovering an acid treated poly(arylene sulfide) (e.g., an acid treated PPS); or alternatively, a) contacting the poly(arylene sulfide) with an aqueous solution comprising an acidic compound to form an acidic mixture, b) heating the acidic mixture in the substantial absence of a gaseous oxidizing atmosphere to an elevated temperature below the melting point of the poly(arylene sulfide), and c) recovering an acid treated poly(arylene sulfide) (e.g., acid treated PPS). The acidic compound can be any organic acid or inorganic acid which is water soluble under the conditions of the acid treatment; alternatively, an organic acid which is water soluble under the conditions of the acid treatment; or alternatively, an inorganic acid which is water soluble under the conditions of the acid treatment. Generally, the organic acid which can be utilized in the acid treatment can be any organic acid which is water soluble under the conditions of the acid treatment. In an embodiment, the organic acid which can be utilized in the acid treatment process can comprise, or consist essentially of, a C₁ to C₁₅ carboxylic acid; alternatively, a C₁ to C₁₀ carboxylic acid; or alternatively, a C₁ to C₅ carboxylic acid. In an embodiment, the organic acid which can be utilized in the acid treatment process can comprise, or consist essentially of, acetic acid, formic acid, oxalic acid, fumaric acid, and monopotassium phthalic acid; alternatively, acetic acid; alternatively, formic acid; alternatively, oxalic acid; or alternatively, fumaric acid. Inorganic acids which can be utilized in the acid treatment process can comprise, or consist essentially of, hydrochloric acid, monoammonium phosphate, sulfuric acid, phosphoric acid, boric acid, nitric acid, sodium dihydrogen phosphate, ammonium dihydrogen phosphate, carbonic acid, and sulfurous acid; alternatively, hydrochloric acid; alternatively, sulfuric acid; alternatively, phosphoric acid; alternatively, boric acid; or alternatively, nitric acid. The amount of the acidic compound present in the mixture (e.g., acidic mixture) can range from 0.01 wt. % to 10 wt. %, from 0.025 wt. % to 5 wt. %, or from 0.075 wt. % to 1 wt. % based on total amount of water in the mixture (e.g., acidic mixture). The amount of poly(arylene sulfide) present in the mixture (e.g., acidic mixture) can range from about 1 wt. % to about 50 wt. %, from about 5 wt. % to about 40 wt. %, or from about 10 wt. % to about 30 wt. %, based upon the total weight of the mixture (e.g., acidic mixture). Generally, the elevated temperature below the melting point of the poly(arylene sulfide) can range from about 165° C. to about 10° C., from about 150° C. to about 15° C., or from about 125° C. to about 20° C. below the melting point of the poly(arylene sulfide); or alternatively, can range from about 175° C. to about 275° C., or from about 200° C. to about 250° C. Additional features of the acid treatment process are described in more detail in U.S. Pat. No. 4,801,644, which is incorporated by reference herein in its entirety.

Generally, the metal cation treatment can comprise a) contacting the poly(arylene sulfide) with water to form a poly(arylene sulfide) slurry, b) contacting the poly(arylene sulfide) slurry with a Group 1 or Group 2 metal compound to form a metal cation mixture, c) heating the metal cation mixture in the substantial absence of a gaseous oxidizing atmosphere to an elevated temperature below the melting point of the poly(arylene sulfide), and d) recovering a metal cation treated poly(arylene sulfide) (e.g., metal cation treated PPS); or alternatively, a) contacting the poly(arylene sulfide) with an aqueous solution comprising a Group 1 or Group 2 metal compound to form a metal cation mixture, b) heating the metal cation mixture in the substantial absence of a gaseous oxidizing atmosphere to an elevated temperature below the melting point of the poly(arylene sulfide), and c) recovering a metal cation treated poly(arylene sulfide) (e.g., metal cation treated PPS). The Group 1 or Group 2 metal compound can be any organic Group 1 or Group 2 metal compound or inorganic Group 1 or Group 2 metal compound which is water soluble under the conditions of the metal cation treatment; alternatively, an organic Group 1 or Group 2 metal compound which is water soluble under the conditions of the metal cation treatment; or alternatively, an inorganic Group 1 or Group 2 metal compound which is water soluble under the conditions of the metal cation treatment. Organic Group 1 or Group 2 metal compounds which can be utilized in the metal cation treatment process can comprise, or consist essentially of, a Group 1 or Group 2 metal C₁ to C₁₅ carboxylate; alternatively, a Group 1 or Group 2 metal C₁ to C₁₀ carboxylate; or alternatively, a Group 1 or Group 2 metal C₁ to C₅ carboxylate (e.g., formate, acetate). Inorganic Group 1 or Group 2 metal compounds which can be utilized in the metal cation treatment process can comprise, or consist essentially of, a Group 1 or Group 2 metal oxide or hydroxide (e.g., calcium oxide or calcium hydroxide). The amount of the Group 1 or Group 2 metal compound present in the mixture (e.g., metal cation mixture) can range from about 50 ppm to about 10,000 ppm, from about 75 ppm to about 7,500 ppm, or from about 100 ppm to about 5,000 ppm. Generally, the amount of the Group 1 or Group 2 metal compound is by the total weight of the mixture (e.g., metal cation mixture). The amount of poly(arylene sulfide) present in the mixture (e.g., metal cation mixture) can range from about 10 wt. % to about 60 wt. %, from about 15 wt. % to about 55 wt. %, or from about 20 wt. % to about 50 wt. %, based upon the total weight of the mixture (e.g., metal cation mixture). Generally, the elevated temperature below the melting point of the poly(arylene sulfide) can range from about 165° C. to about 10° C., from about 150° C. to about 15° C., or from about 125° C. to about 20° C. below the melting point of the poly(arylene sulfide); or alternatively, can range from about 125° C. to about 275° C., or from about 150° C. to about 250° C. Additional features of the acid treatment process are provided in EP patent publication 0103279 A1, which is incorporated by reference herein in its entirety.

Once the poly(arylene sulfide) has been acid treated and/or metal cation treated, the acid treated and/or metal cation treated poly(arylene sulfide) can be separated from a treatment solution via a filtration step. Generally, the process/steps for recovering the acid treated and/or metal cation treated poly(arylene sulfide) can be the same steps as those for separating and/or isolating the poly(arylene sulfide) polymer particles from the reaction mixture.

Once the poly(arylene sulfide) polymer particles have been recovered (either in raw, acid treated, metal cation treated, or acid treated and metal cation treated form), the poly(arylene sulfide) can be dried and optionally cured. In an embodiment, a process for producing a poly(arylene sulfide) polymer can comprise a step of drying at least a portion of the poly(arylene sulfide) polymer particles to obtain a dried poly(arylene sulfide) polymer.

Generally, the poly(arylene sulfide) drying process can be performed at any temperature which can substantially dry the poly(arylene sulfide), to yield a dried poly(arylene sulfide) polymer. Preferably, the drying process should result in substantially no oxidative curing of the poly(arylene sulfide). For example, if the drying process is conducted at a temperature of or above about 100° C., the drying should be conducted in a substantially non-oxidizing atmosphere (e.g., in a substantially oxygen free atmosphere or at a pressure less than atmospheric pressure, for example under vacuum). When the drying process is conducted at a temperature below about 100° C., the drying process can be facilitated by performing the drying at a pressure less than atmospheric pressure so the liquid component can be vaporized from the poly(arylene sulfide). When the poly(arylene sulfide) drying is performed below about 100° C., the presence of a gaseous oxidizing atmosphere will generally not result in a detectable curing of the poly(arylene sulfide). Generally, air is considered to be a gaseous oxidizing atmosphere.

Poly(arylene sulfide) can be cured by subjecting the poly(arylene sulfide) polymer particles to an elevated temperature, below its melting point, in the presence of gaseous oxidizing atmosphere, thereby forming cured poly(arylene sulfide) polymer (e.g., cured PPS). Any suitable gaseous oxidizing atmosphere can be used. For example, suitable gaseous oxidizing atmospheres include, but are not limited to, oxygen, any mixture of oxygen and an inert gas (e.g., nitrogen), or air; or alternatively air. The curing temperature can range from about 1° C. to about 130° C. below the melting point of the poly(arylene sulfide), from about 10° C. to about 110° C. below the melting point of the poly(arylene sulfide), or from about 30° C. to about 85° C. below the melting point of the poly(arylene sulfide). Agents that affect curing, such as peroxides, accelerants, and/or inhibitors, can be incorporated into the poly(arylene sulfide).

In an aspect, the poly(arylene sulfide) polymer described herein can further comprise one or more additives. In an embodiment, the poly(arylene sulfide) polymer can ultimately be used or blended in a compounding process, for example, with various additives, such as polymers, fillers, fibers, reinforcing materials, pigments, nucleating agents, antioxidants, ultraviolet (UV) stabilizers (e.g., UV absorbers), lubricants, fire retardants, heat stabilizers, carbon black, plasticizers, corrosion inhibitors, mold release agents, pigments, titanium dioxide, clay, mica, processing aids, adhesives, tackifiers, and the like, or combinations thereof.

In an embodiment, fillers which can be utilized include, but are not limited to, mineral fillers, inorganic fillers, or organic fillers, or mixtures thereof. In some embodiments, the filler can comprise, or consist essentially of, a mineral filler; alternatively, an inorganic filler; or alternatively, an organic filler. In an embodiment, mineral fillers which can be utilized include, but are not limited to, glass fibers, milled fibers, glass beads, asbestos, wollastonite, hydrotalcite, fiberglass, mica, talc, clay, calcium carbonate, magnesium hydroxide, silica, potassium titanate fibers, rockwool, or any combination thereof; alternatively, glass fibers; alternatively, glass beads; alternatively, asbestos; alternatively, wollastonite; alternatively, hydrotalcite; alternatively, fiberglass; alternatively, silica; alternatively, potassium titanate fibers; or alternatively, rockwool. Exemplary inorganic fillers can include, but are not limited to, aluminum flakes, zinc flakes, fibers of metals such as brass, aluminum, zinc, or any combination thereof; alternatively, aluminum flakes; alternatively, zinc flakes; or alternatively, fibers of metals such as brass, aluminum, and zinc. Exemplary organic fillers can include, but are not limited to, carbon fibers, carbon black, graphene, graphite, a fullerene, a buckyball, a carbon nanofiber, a carbon nanotube, or any combination thereof; alternatively, carbon fibers; alternatively, carbon black; alternatively, graphene; alternatively, graphite; alternatively, a fullerene; alternatively, a buckyball; alternatively, a carbon nanofiber; or alternatively, a carbon nanotube. Fibers such as glass fibers, milled fibers, carbon fibers and potassium titanate fibers, and inorganic fillers such as mica, talc, and clay can be incorporated into the composition, which can provide molded articles to provide a composition which can have improved properties.

In an embodiment, pigments which can be utilized include, but are not limited to, titanium dioxide, zinc sulfide, or zinc oxide, and mixtures thereof.

In an embodiment, UV absorbers which can be utilized include, but are not limited to, oxalic acid diamide compounds or sterically hindered amine compounds, and mixtures thereof.

In an embodiment, lubricants which can be utilized include, but are not limited to, polyaphaolefins, polyethylene waxes, polyethylene, high density polyethylene (HDPE), polypropylene waxes, and paraffins, and mixtures thereof.

In an embodiment, the fire retardant can be a phosphorus based fire retardant, a halogen based fire retardant, a boron based fire retardant, an antimony based fire retardant, an amide based fire retardant, or any combination thereof. In an embodiment, phosphorus based fire retardants which can be utilized include, but are not limited to, triphenyl phosphate, tricresyl phosphate, a phosphate obtained from a mixture of isopropylphenol and phenol and phosphorus oxychloride, or phosphate esters obtained from difunctional phenols (e.g., benzohydroquinone or bisphenol A), an alcohol, or a phenol and phosphorus oxychloride; alternatively, triphenyl phosphate; alternatively, tricresyl phosphate; alternatively, a phosphate obtained from a mixture of isopropylphenol and phenol and phosphorus oxychloride; or alternatively, phosphate esters obtained from difunctional phenols (e.g., benzohydroquinone or bisphenol A), an alcohol, or a phenol and phosphorus oxychloride. In an embodiment, halogen based fire retardants which can be utilized include, but are not limited to, brominated compounds. In some embodiments, the halogen based fire retardants which can be utilized include, but are not limited to, decabromobiphenyl, pentabromotoluene, decabromobiphenyl ether, hexabromobenzene, or brominated polystyrene. In an embodiment, stabilizers which can be utilized include, but are not limited to, sterically hindered phenols and phosphite compounds.

In an aspect, the poly(arylene sulfide) described herein can further be processed by melt processing. In an embodiment, melt processing can generally be any process, step(s) which can render the poly(arylene sulfide) in a soft or “moldable state.” In an embodiment, the melt processing can be a step wherein at least part of the polymer composition or mixture subjected to the process is in molten form. In some embodiments, the melt processing can be performed by melting at least part of the polymer composition or mixture. In some embodiments, the melt processing step can be performed with externally applied heat. In other embodiments, the melt processing step itself can generate the heat necessary to melt (or partially melt) the mixture, polymer, or polymer composition. In an embodiment, the melt processing step can be an extrusion process, a melt kneading process, or a molding process. In some embodiments, the melt processing step of any method described herein can be an extrusion process; alternatively, a melt kneading process; or alternatively, a molding process. It should be noted, that when any process described herein employs more than one melt processing step, that each melt process step is independent of each other and thus each melt processing step can use the same or different melt processing method. Other melt processing methods are known to those having ordinary skill in the art can be utilized as the melt processing step.

The poly(arylene sulfide) can be formed or molded into a variety of components or products for a diverse range of applications and industries. For example, the poly(arylene sulfide) can be heated and molded into desired shapes and composites in a variety of processes, equipment, and operations. For example, the poly(arylene sulfide) can be subjected to heat, compounding, injection molding, blow molding, precision molding, film-blowing, extrusion, and so forth. Additionally, additives, such as those mentioned herein, can be blended or compounded within the poly(arylene sulfide) (e.g., PPS). The output of such techniques can include, for example, polymer intermediates or composites including the poly(arylene sulfide) (e.g., PPS), and manufactured product components or pieces formed from the poly(arylene sulfide) (e.g., PPS), and so on. These manufactured components can be sold or delivered directly to a user. On the other hand, the components can be further processed or assembled in end products, for example, in the industrial, consumer, automotive, aerospace, solar panel, and electrical/electronic industries, which can need polymers that have conductivity, high strength, and high modulus, among other properties. Some examples of end products include without limitation synthetic fibers, textiles, filter fabric for coal boilers, papermaking felts, electrical insulation, specialty membranes, gaskets, and packing materials.

In an embodiment, a process for producing a poly(phenylene sulfide) polymer comprises (a) contacting N-methyl-2-pyrrolidone, sodium hydrosulfide and sodium hydroxide to produce a sulfur complex mixture, wherein the sulfur complex mixture comprises sodium N-methyl-4-aminobutanoate; (b) continuously introducing at least a portion of the sulfur complex mixture and p-dichlorobenzene to a reaction vessel to form a reaction mixture, wherein the reaction vessel can be continuously stirred, and wherein the reaction vessel can comprise a single reaction zone; (c) continuously removing a portion of the reaction mixture from the reaction vessel to yield a reaction product mixture; and (d) processing at least a portion of the reaction product mixture to obtain a poly(phenylene sulfide) polymer, wherein the poly(phenylene sulfide) polymer is a single stage polymerization product. In such embodiment, the poly(phenylene sulfide) polymer can have a Mₙ of from about 20,000 g/mol to about 60,000 g/mol.

In an embodiment, a process for producing a poly(phenylene sulfide) polymer comprises (a) contacting sodium hydrosulfide, N-methyl-2-pyrrolidone, acetic anhydride and sodium hydroxide to produce a sulfur complex mixture, wherein the sulfur complex mixture comprises sodium N-methyl-4-aminobutanoate; (b) dehydrating at least a portion of the sulfur complex mixture to yield a dehydrated sulfur complex mixture; (c) continuously introducing at least a portion of the dehydrated sulfur complex mixture and p-dichlorobenzene to a reaction vessel to form a reaction mixture, wherein the reaction vessel is continuously stirred, and wherein the reaction vessel comprises a single reaction zone; (d) continuously removing a portion of the reaction mixture from the reaction vessel to yield a reaction product mixture; and (e) cooling at least a portion of the reaction product mixture to a temperature of less than about 200° C. to obtain a poly(phenylene sulfide) polymer, wherein the poly(phenylene sulfide) polymer is a single stage polymerization product, and wherein the poly(phenylene sulfide) polymer has a molecular weight distribution of from about 1,000 to about 90,000. In such embodiment, the sulfur complex mixture can be continuously dehydrated prior to (c) continuously introducing the dehydrated sulfur complex mixture and p-dichlorobenzene to the reaction vessel. In such embodiment, (e) cooling the reaction product mixture can be carried out via quench cooling.

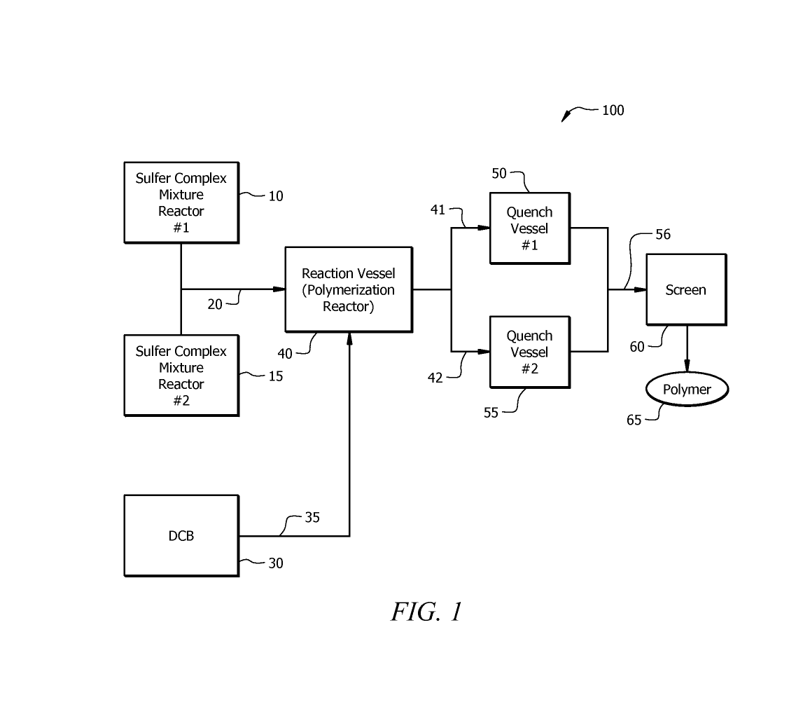

Referring to FIG. 1, an embodiment of a poly(arylene sulfide) polymer continuous production system 100 is disclosed. The polymer continuous production system 100 generally comprises a first sulfur complex mixture reactor 10, a second sulfur complex mixture reactor 15, a halogenated aromatic compound (e.g., p-dichlorobenzene, DCB) vessel 30, a reaction vessel or polymerization reactor 40, a first quench vessel 50, a second quench vessel 55, and a washing vessel 60. Various system components can be in fluid communication via one or more conduits (e.g., pipes, tubing, flow lines, etc.) suitable for the conveyance of a particular stream, for example as shown in detail by the numbered streams in FIG. 1.

Referring to the embodiment of FIG. 1, a sulfur complex mixture stream 20 can be communicated from the first sulfur complex mixture reactor 10 and/or the second sulfur complex mixture reactor 15 to the polymerization reactor 40. While the embodiment of FIG. 1 only depicts two sulfur complex mixture reactors, and as will be appreciated by one of skill in the art, any suitable number of sulfur complex mixture reactors can be used, such as for example two, three, four, five, six, or more sulfur complex mixture reactors can be used for preparing the sulfur complex mixture. The use of two or more sulfur complex mixture reactors can ensure that the sulfur complex mixture stream 20 can be continuously communicated to the polymerization reactor 40. In an alternative embodiment, only one larger sulfur complex mixture reactor can be used to produce a sulfur complex mixture in excess when compared to the intake requirements for the polymerization reactor, and the excess sulfur complex mixture could be stored in a storage vessel to ensure a continuous supply of sulfur complex mixture to the polymerization reactor 40.

Referring to the embodiment of FIG. 1, a halogenated aromatic compound (e.g., DCB) stream 35 can be communicated from the halogenated aromatic compound vessel 30 to the polymerization reactor 40. A reaction product mixture stream 41 can be communicated from the polymerization reactor 40 to the first quench vessel 50. A reaction product mixture stream 42 can be communicated from the polymerization reactor 40 to the second quench vessel 55.

In an embodiment, continuously forming poly(arylene sulfide) polymer particles can comprise operating two quench vessels (50, 55) in parallel. Referring to the embodiment of FIG. 1, the first quench vessel 50 and the second quench vessel 55 could operate as batch vessels, and as such two quench vessels operated in parallel can provide for a continuous process. Further, as will be appreciated by one of skill in the art, and with the help of this disclosure, when two quench vessels are operated in parallel, at least one quench vessel would be available to receive the reaction product mixture, and the output from the quench vessels could ensure a continuous process downstream the quench vessels. While the embodiment of FIG. 1 only depicts two quench vessels, and as will be appreciated by one of skill in the art, any suitable number of quench vessels can be used, such as for example one, two, three, four, five, six, or more quench vessels can be used for supplying a continuous stream of a quenched mixture.

Referring to the embodiment of FIG. 1, a quenched mixture stream 56 can be communicated from the first quench vessel 50 and/or the second quench vessel 55 to the washing vessel 60, wherein the particulate poly(arylene sulfide) polymer 65 can be retained on a screen (e.g., shaker screen) and further recovered. While the embodiment of FIG. 1 only depicts one washing vessel, and as will be appreciated by one of skill in the art, any suitable number of washing vessels can be used for washing and recovering the particulate poly(arylene sulfide) polymer 65, such as for example two, three, four, five, six, or more washing vessels can be used for washing and recovering the particulate poly(arylene sulfide) polymer 65.

In an embodiment, the process for continuously producing a poly(arylene sulfide) polymer as disclosed herein advantageously displays improvements in one or more process characteristics when compared to an otherwise similar batch process. Generally, batch polymerization processes can require larger-size equipment in order to produce the same amount of polymer in a given time frame. In an embodiment, the process for continuously producing a poly(arylene sulfide) polymer as disclosed herein can advantageously allow for the use of smaller-size equipment to obtain an otherwise similar production rate when compared to a batch process for the production of an otherwise similar polymer. Further, the use of smaller equipment can advantageously allow for a more efficient heat transfer (e.g., heating, cooling).

In an embodiment, the process for continuously producing a poly(arylene sulfide) polymer as disclosed herein can advantageously allow for reduced “down time” (e.g., higher on-stream factor).

In an embodiment, the process for continuously producing a poly(arylene sulfide) polymer as disclosed herein can advantageously provide for reduced labor costs.

In an embodiment, the process for continuously producing a poly(arylene sulfide) polymer as disclosed herein can advantageously provide for a specific MWD, owing to a distribution of residence times inside the reaction vessel, which in turn could lead to unique or specific polymer properties.

In an embodiment, the process for continuously producing a poly(arylene sulfide) polymer as disclosed herein can advantageously allow for steadier operation. Generally, the steadier operation can refer to much less cycling of temperatures and pressures, which in turn can increase efficiency and/or equipment life. Additional advantages of the process for the production of a poly(arylene sulfide) polymer as disclosed herein can be apparent to one of skill in the art viewing this disclosure.

### EXAMPLES

The subject matter having been generally described, the following examples are given as particular embodiments of the disclosure and to demonstrate the practice and advantages thereof. It is understood that the examples are given by way of illustration and are not intended to limit the specification of the claims to follow in any manner.

### Example 1

A mathematical model (e.g., computer model) was developed to assess the feasibility of a continuous polymerization reactor for producing poly(phenylene sulfide) (PPS). The model allowed unequal reactivity. The model also tracked individually up to trimer levels, wherein trimers have 3 S, where “S” is an abbreviation for sulfur atom. The model also treated together all oligomers and polymers with greater than 3 S atoms (4+ mers). For purposes of the computer model, the “mers” are defined per S atom: a dimer has 2 S atoms, a trimer has 3 S atoms, a tetramer has 4 S atoms, etc. The mathematical model developed for the continuous polymerization reactor includes a novel “chi” term in addition to new reaction parameters, and a novel method of obtaining the reaction parameters, when compared to conventional mathematical models for polymerization reactors. Examples of conventional mathematical models for polymerization reactors are described in D. R. Fahey, H. D. Hensley, C. E. Ash, and D. R. Senn, “Poly(p-Phenylene sulfide) Synthesis: A Step-Growth Polymerization with Unequal Step Reactivity,” R&D Report 10752-91, 1992; and S. K. Gupta and A. Kumar, “Reaction Engineering of Step Growth Polymerization,” Plenum Press, New York, 1987; each of which is incorporated by reference herein in its entirety.

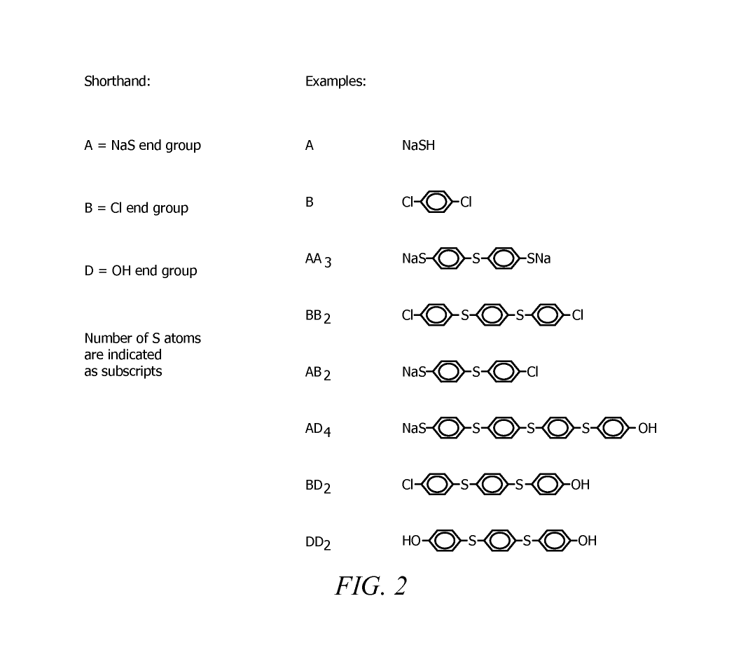

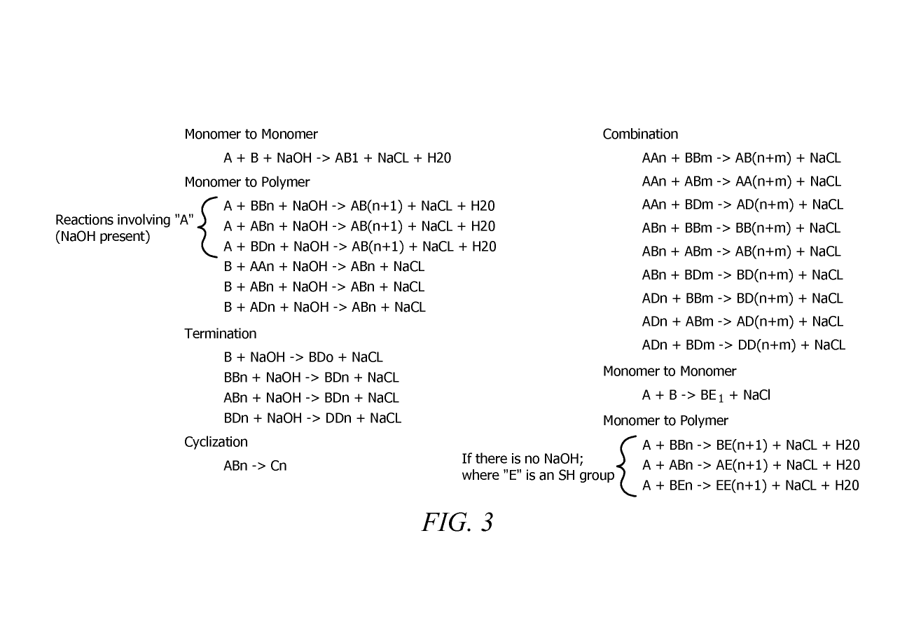

The terminology used in the model is shown in FIG. 2, along with examples of dimers (e.g., BB₂, AB₂, BD₂, DD₂), trimers (AA₃), and tetramers (AD₄). A schematic of the reactions used to develop the model is displayed in FIG. 3. For purposes of the model of the disclosure herein, n and/or m represent the number of sulfur atoms in the component being described. Further, for purposes of the model of the disclosure herein, the presence of NaOH signifies that N-methyl-4-aminobutanoate (SMAB) is present. Further, for purposes of the model of the disclosure herein, if NaOH is present, then the reaction proceeds. Further, for purposes of the model of the disclosure herein, if NaOH is absent (gets consumed in the reaction), the termination reactions occur and the reaction will stop progressing. As will be appreciated by one of skill in the art, and with the help of this disclosure, when termination reactions occur, such termination reactions cause a particular end of a PPS chain to no longer be reactive. Generally, the reactions are run with some excess caustic (e.g., NaOH).

Generally, unequal reactivity means that first oligomers (e.g., dimers), second oligomers (e.g., trimers), and third oligomers (e.g., tetramers) do not react at the same kinetic rates. In the case of the model used in the present disclosure, generally the longer oligomers have a faster rate of reaction. The model was developed by setting up a series of differential equations for each of the reactions listed in FIG. 3. The set reaction equations were programmed into MATLAB®. Each reaction had a unique kinetic rate constant. Each of the rate constants had a unique Arrhenius equation to set the magnitude and temperature dependence. As possible, laboratory data was used on model compound reactions to determine parameters of interest. The parameters were further “fit” by using a large variety of reaction cycle data with variations in the recipe for each cycle. The flow rate, molecular weight, and selected remaining reactants were compared to what the model predicted in each of those cases. The model was set up to introduce slight variations to the multiple parameters in a random fashion. The large set of resulting predictions was then compared to actual data for multiple reactions. The parameter set that most closely matched the data was kept. This process of generating a large set of resulting predictions was then repeated until a satisfactory fit was obtained using the same parameters for a variety of cycles and recipes. Additionally, species concentrations were tracked and compared with spectroscopic reaction data as possible.

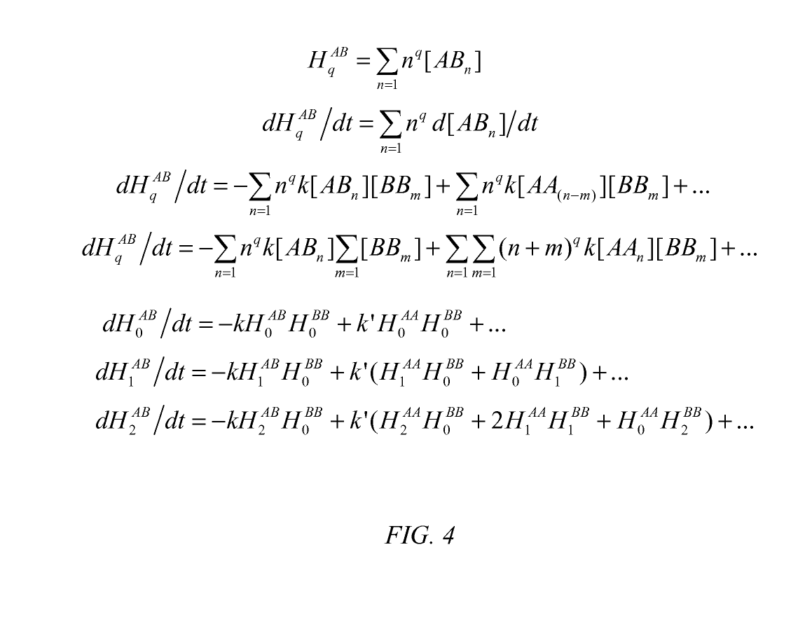

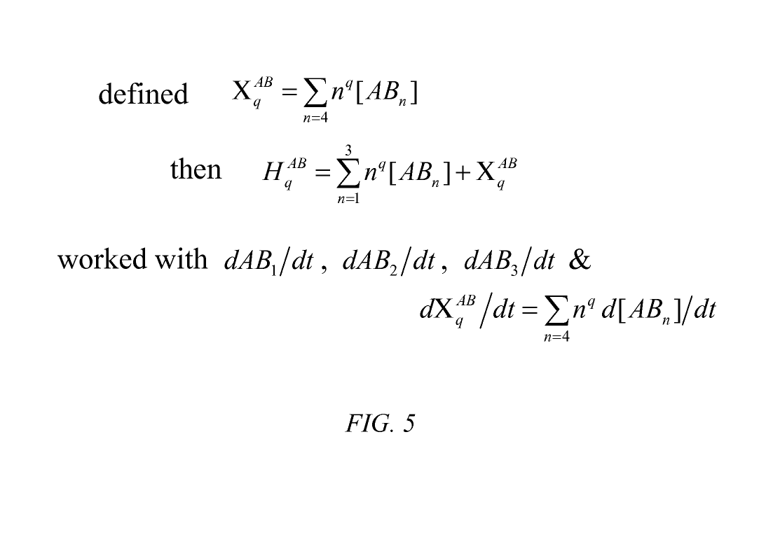

A system of equations was developed, as outlined in FIG. 4. This system of equations requires equal reactivity, however the reaction is known to have unequal reactivity for the first 3 to 4 monomer units, and higher units can be assumed constant. For purposes of the model of the disclosure herein, q represents the moment number (e.g., 0^{th} moment, 1^{st} moment, 2^{nd} moment, etc.), k is the reaction rate constant, and H is the moment. The moments (along with all the species' concentrations) were obtained from the equations in FIG. 4. A new parameter (X_{q}^{AB}, “chi moment”) was developed as outlined in FIG. 5, to enable unequal reactivity for the first 3 to 4 monomer units. In order to obtain the chi moments X, the first three terms of the summation were taken out the moments H, and for X the summation was from 4 to infinity. For X, it was possible to factor k in the summation because at n and/or m=4 and above, the reaction rates are considered all equal. The first three terms that were removed from H were then allowed to each have a unique k value.

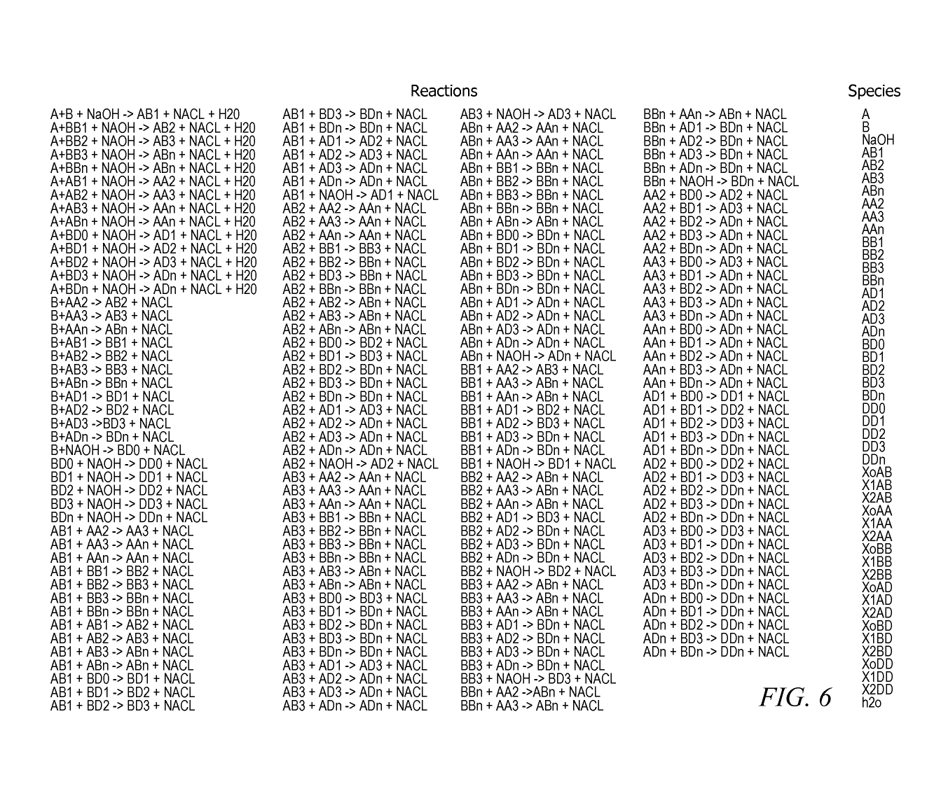

While many additional equations besides the equations outlined in FIGS. 4 and 5 could be written, such equations are accountable through the equations presented in FIGS. 4 and 5. Fewer equations allow for a more realistic modeling, as the time required to run the model is reduced. Equal reactivity was assumed for 4+ mers. The reactions as used in the model are given in FIG. 6.

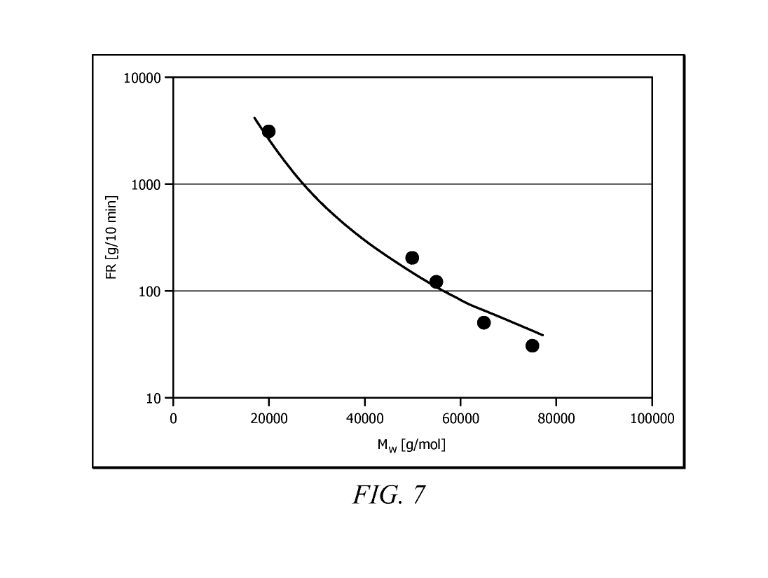

The moments were then used to calculate molecular weight averages. From correlations (e.g., FIG. 7), the molecular weight data was converted to a flow rate to compare further with experimental data. Mathematically, it was possible to convert quickly between equations for batch or continuous systems, given that the kinetics and other parameters are the same for batch as they are for continuous. A difference between batch and continuous is that the equations are converted to describe the continuous nature, resulting in a residence time distribution, inflow, out flow, etc., that is different for continuous when compared to the batch. As will be appreciated by one of skill in the art, and with the help of this disclosure, whether a system is batch or continuous, a reactive time dependent mass balance equation is used. Only the equations would change, not the kinetics, allowing an expansion to continuous systems.

One of the studied relationships was between flow rate and weight average molecular weight (M_{w}), and the result is displayed in FIG. 7. As expected, the flow rate (FR) decreases with increasing molecular weight. The graph displayed in FIG. 7 was obtained by using data for M_{w} vs. FR on several experimental samples. The graph displayed in FIG. 7 was used for converting molecular weight values obtained from the mathematical model to the corresponding FRs.

### Example 2

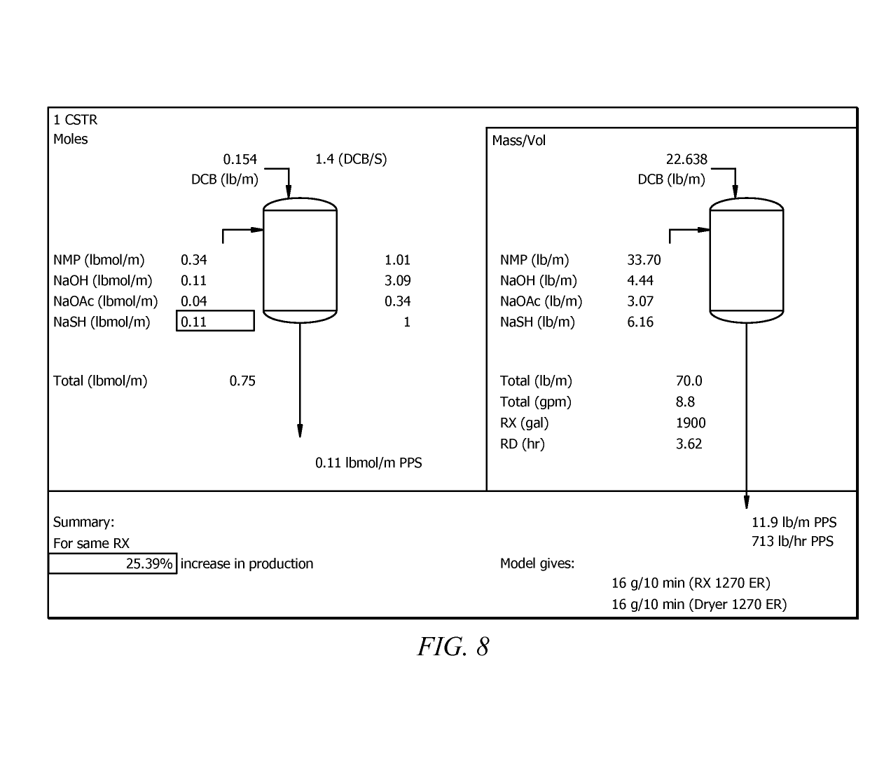

The mathematical model developed as described in Example 1 was used for modeling the properties of a polymer obtained from a continuous polymerization reactor. Each of the chemical reactions discussed in Example 1 requires a kinetic constant and an activation energy, Ea, for temperature dependence. The model can predict several measurable values, such as for example reaction mixture composition, the molecular weight of product resin, flow rate to molecular weight correlation, etc. Accurate reaction parameters (e.g., kinetic constants in Arrhenius equations; pre-exponential factors and Arrhenius activation energy for each reaction) were needed for the model. Experimental data were obtained for batch runs, where a large number of different temperature cycles and recipes were used. The components (e.g., reactants) were tracked as they were consumed in several batches. The resulting batches were analyzed to obtain the flow rate of the resulting polymer and the amount of p-dichlorobenzene (DCB) remaining. The model was input with the temperature cycle and recipe to correspond to each of these batches, while the reaction parameters were kept consistent for the modeling. The reaction parameters were manipulated until one consistent set of parameters was obtained that was able to predict all the different data well. These reaction parameters were used to mathematically run a continuous stirred tank reactor (CSTR), via material balance, using the same kinetics from the model. FIG. 8 outlines a typical reaction model and a typical recipe used. The example outlined in FIG. 8 was modeled at 470° F. and about 150 psig. RX=reaction, RX (gal) represents the reactor size in gallons, and RD represents the average residence time. Referring to the embodiment of FIG. 8, an increase in production refers to an estimated increase for continuous over batch.

Generally, the rate at which the polymer composition flows through an orifice can be reported as a rate measured by one or more methods. Extrusion Rate (ER) is based upon ASTM D 1238-13, Procedure B-Automatically Timed Flow Rate Procedure, Condition 315/5.0 modified to 1) use an orifice having a 2.096±0.005 mm diameter and a 31.75±0.05 mm length, 2) use a 345 gram drive weight instead of a 5000 gram drive weight, 3) use a 5 minute preheat time, and 4) use a 315.6° C. test temperature. 1270 Extrusion Rate (1270ER) is based upon ASTM D 1238-13, Procedure B-Automatically Timed Flow Rate Procedure, Condition 315/5.0 modified to 1) use an orifice having a 2.096±0.005 mm diameter and a 31.75±0.05 mm length, 2) use a 1270 gram drive weight instead of a 5000 gram drive weight, 3) use a 5 minute preheat time, and 4) use a 315.6° C. test temperature. Melt Flow (MF) is based upon ASTM D 1238-13, Procedure B-Automatically Timed Flow Rate Procedure, Condition 315/5.0 modified to 3) use a 5 minute preheat time, and 4) use a 315.6° C. test temperature. Each of these methods reports the flow of the polymer composition in units of grams/10 minutes.

The flow rate (FR) refers to the amount of a polymer which can be forced through a melt indexer orifice of 0.0825 inch diameter when subjected to an indicated force (e.g., 5 kg) in ten minutes at 190° C., as determined in accordance with ASTM D1238. Method 1270 ER was also used to perform melt flow analysis. Method 1270 ER is similar to other methods used to determine flow rate (e.g., ASTM D1238) or high load melt index (HLMI), except that the orifice and load are different, as previously described herein.

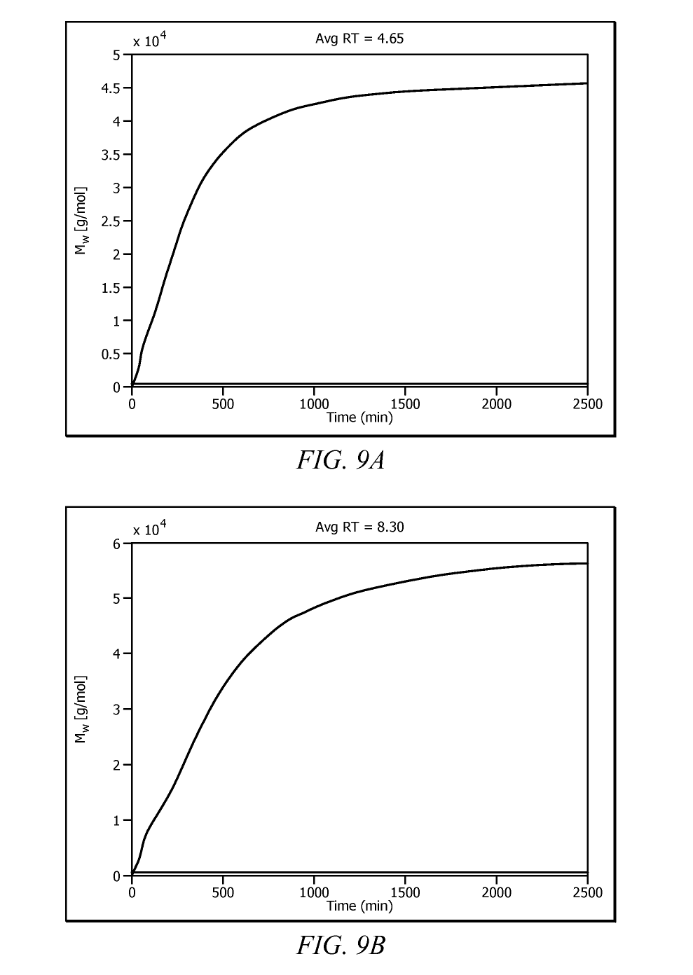

Another important relationship in the case of continuous polymerization reactors is between molecular weight of resulting polymer and average residence time or residence time (RT). As expected, the data in FIG. 9A and FIG. 9B shows that the greater the average RT, the higher the molecular weight (Mw). The data in FIGS. 9A and 9B is simulated with the mathematical model described in Example 1, wherein in both cases the reaction temperature was 470° F., and the molar ratio of NaOH to sulfur was 1.02. The molar ratio of DCB to sulfur was 1.36 for FIG. 9A, and 1.3 for FIG. 9B. As expected, the higher the average RT (FIG. 9B), the higher the M. Utilizing the graph from FIG. 7, for the polymer simulated in FIG. 9A, the FR was estimated to be 201 g/10 min, and the 1270 ER was estimated to be 13 g/10 min. Utilizing the graph from FIG. 7, for the polymer simulated in FIG. 9B, the FR was estimated to be 99 g/10 min, and the 1270 ER was estimated to be 6 g/10 min.

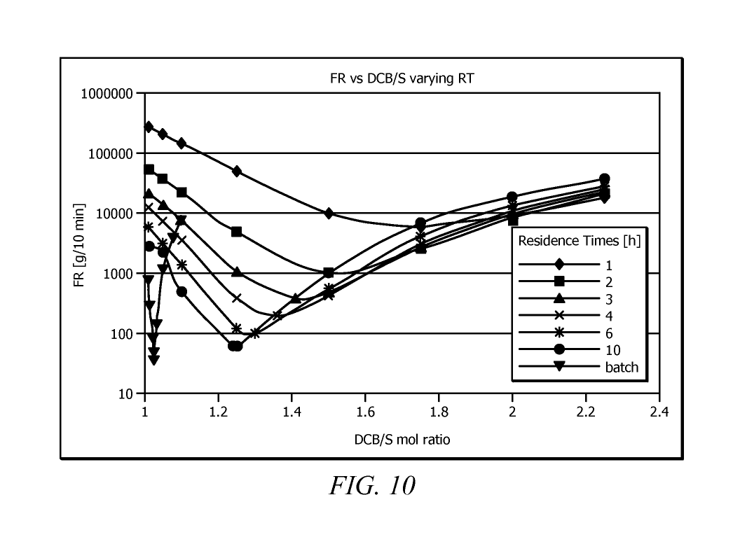

The relationship between FR and DCB to sulfur molar ratio for various average residence times was also investigated by using the mathematical model of Example 1. Six different average RTs were used, with values ranging from 1 h to 10 h, and the data was further compared to a simulation of a batch reactor. When seeking high molecular weight polymers, a low flow rate is desired. For all the curves plotted in FIG. 10, it can be seen that there is an optimum value for the molar ratio of DCB to sulfur (DCB/S mole ratio) which leads to the lowest flow rate for a particular average RT, which in turns means the obtained polymer has the highest M_{w}. Although the model will predict a very low flow rate (corresponding to a very high M_{w}), it is expected that a limit will be reached due to polymer solubility and polymer mobility limits during the reaction.

For the purpose of any U.S. national stage filing from this application, all publications and patents mentioned in this disclosure are incorporated herein by reference in their entireties, for the purpose of describing and disclosing the constructs and methodologies described in those publications, which might be used in connection with the methods of this disclosure. Any publications and patents discussed herein are provided solely for their disclosure prior to the filing date of the present application. Nothing herein is to be construed as an admission that the inventors are not entitled to antedate such disclosure by virtue of prior invention.

In any application before the United States Patent and Trademark Office, the Abstract of this application is provided for the purpose of satisfying the requirements of 37 C.F.R. §1.72 and the purpose stated in 37 C.F.R. §1.72(b) “to enable the United States Patent and Trademark Office and the public generally to determine quickly from a cursory inspection the nature and gist of the technical disclosure.” Therefore, the Abstract of this application is not intended to be used to construe the scope of the claims or to limit the scope of the subject matter that is disclosed herein. Moreover, any headings that can be employed herein are also not intended to be used to construe the scope of the claims or to limit the scope of the subject matter that is disclosed herein. Any use of the past tense to describe an example otherwise indicated as constructive or prophetic is not intended to reflect that the constructive or prophetic example has actually been carried out.

The present disclosure is further illustrated by the following examples, which are not to be construed in any way as imposing limitations upon the scope thereof. On the contrary, it is to be clearly understood that resort can be had to various other aspects, embodiments, modifications, and equivalents thereof which, after reading the description herein, can be suggest to one of ordinary skill in the art without departing from the spirit of the present invention or the scope of the appended claims.

### Additional Disclosure

The following are enumerated embodiments are provided as non-limiting examples.

A first embodiment, which is a process comprising:

(a) contacting a sulfur compound and a polar organic compound to produce a sulfur complex mixture, wherein the sulfur complex mixture comprises a sulfur complex;

(b) continuously introducing at least a portion of the sulfur complex mixture and at least one halogenated aromatic compound having two halogens to a reaction vessel to form a reaction mixture, wherein the reaction vessel is continuously stirred, and wherein the reaction vessel comprises a single reaction zone;

(c) continuously removing a portion of the reaction mixture from the reaction vessel to yield a reaction product mixture; and

(d) processing at least a portion of the reaction product mixture to obtain a poly(arylene sulfide) polymer, wherein the poly(arylene sulfide) polymer is the product of a single stage polymerization.

A second embodiment, which is the process of the first embodiment, wherein the poly(arylene sulfide) polymer has a number average molecular weight of from about 10,000 g/mol to about 60,000 g/mol.

A third embodiment, which is the process of the first through the second embodiments, wherein the reaction vessel comprises a single continuous stirred tank reactor.

A fourth embodiment, which is the process of the first through the third embodiments, wherein the reaction vessel comprises a single continuous reaction volume.

A fifth embodiment, which is the process of the first through the fourth embodiments, wherein the reaction vessel excludes reactor partitions, wherein reactor partitions define two or more reaction zones.

A sixth embodiment, which is the process of the first through the fifth embodiments, wherein the reaction vessel excludes a stirred tank cascade.

A seventh embodiment, which is the process of the first through the sixth embodiments, wherein the reaction vessel excludes a flow tube reactor.

An eighth embodiment, which is the process of the first through the seventh embodiments, wherein the single stage polymerization excludes a prepolymerization stage.

A ninth embodiment, which is the process of the first through the eighth embodiments, wherein a molecular weight of the poly(arylene sulfide) polymer obtained by (d) processing the reaction product mixture is not increased in a subsequent polymerization reaction.

A tenth embodiment, which is the process of the first through the ninth embodiments, wherein the poly(arylene sulfide) polymer obtained by (d) processing the reaction product mixture is not further contacted with a sulfur compound and/or a sulfur complex mixture.

An eleventh embodiment, which is the process of the first through the tenth embodiments, wherein the poly(arylene sulfide) polymer obtained by (d) processing the reaction product mixture is not further slurried in a polar organic compound and heated to a temperature of greater than about 180° C.

A twelfth embodiment, which is the process of the first through the eleventh embodiments, wherein the single stage polymerization excludes obtaining a first poly(arylene sulfide) polymer having a first molecular weight and subsequently polymerizing the first poly(arylene sulfide) polymer to yield a second poly(arylene sulfide) polymer having a second molecular weight, wherein the second molecular weight is greater than the first molecular weight.

A thirteenth embodiment, which is the process of the first through the twelfth embodiments, wherein (d) processing the reaction product mixture comprises continuously forming poly(arylene sulfide) polymer particles.

A fourteenth embodiment, which is the process of the thirteenth embodiment, wherein continuously forming poly(arylene sulfide) polymer particles comprises cooling at least a portion of the reaction product mixture to a temperature of less than about 180° C.

A fifteenth embodiment, which is the process of the thirteenth through the fourteenth embodiments, wherein continuously forming poly(arylene sulfide) polymer particles comprises quenching at least a portion of the reaction product mixture by adding a quench liquid thereto to form a quenched mixture, wherein the quenched mixture comprises poly(arylene sulfide) polymer particles.

A sixteenth embodiment, which is the process of the thirteenth embodiment, wherein continuously forming poly(arylene sulfide) polymer particles comprises operating at least two flash units in parallel.

A seventeenth embodiment, which is the process of the sixteenth embodiment, wherein a flash unit removes at least a portion of a liquid phase of the reaction product mixture from at least a portion of the reaction product mixture to form a flashed poly(arylene sulfide) polymer mixture, wherein the flashed poly(arylene sulfide) polymer mixture comprises poly(arylene sulfide) polymer particles.

An eighteenth embodiment, which is the process of the sixteenth through the seventeenth embodiments, wherein the at least two flash units are downstream the reaction vessel.

A nineteenth embodiment, which is the process of the first through the eighteenth embodiments, wherein the reaction vessel is heated to a temperature of from about 180° C. to about 290° C.

A twentieth embodiment, which is the process of the first through the nineteenth embodiments, wherein the reaction vessel is heated by a) external heating, b) external heating using a jacket, c) internal heating, d) coil heating, e) heating internal elements of the reaction vessel, wherein the internal elements comprise a shaft and/or a stifling tool, f) looping the reaction mixture through an external heat exchanger, or g) combinations thereof.

A twenty-first embodiment, which is the process of the first through the twentieth embodiments, wherein the reaction vessel has a pressure of from about 0 psig to about 400 psig.

A twenty-second embodiment, which is the process of the first through the twenty-first embodiments, wherein an equivalent ratio of the halogenated aromatic compound having two halogens to sulfur compound is from about 0.8 to about 2.

A twenty-third embodiment, which is the process of the first through the twenty-second embodiments, wherein the sulfur compound comprises thiosulfates, thioureas, thioamides, elemental sulfur, thiocarbamates, metal disulfides, metal oxysulfides, thiocarbonates, organic mercaptans, organic mercaptides, organic sulfides, alkali metal sulfides, lithium sulfide, sodium sulfide, potassium sulfide, rubidium sulfide, cesium sulfide, alkali metal bisulfides, lithium hydrosulfide, sodium hydrosulfide, potassium hydrosulfide, rubidium hydrosulfide, cesium hydrosulfide, hydrogen sulfide, or combinations thereof.

A twenty-fourth embodiment, which is the process of the first through the twenty-third embodiments, wherein the sulfur complex comprises sodium N-methyl-4-aminobutanoate, alkali metal carboxylates, lithium benzoate, sodium benzoate, potassium benzoate, rubidium benzoate, cesium benzoate, lithium acetate, sodium acetate, potassium acetate, rubidium acetate, cesium acetate, poly(arylene sulfide) oligomers, poly(phenylene sulfide) oligomers, thio-N-methyl-2-pyrrolidone, or combinations thereof.

A twenty-fifth embodiment, which is the process of the first through the twenty-fourth embodiments, wherein (a) contacting a sulfur compound and a polar organic compound further comprises contacting therewith an alkali metal hydroxide, lithium hydroxide, sodium hydroxide, potassium hydroxide, rubidium hydroxide, cesium hydroxide, or combinations thereof.

A twenty-sixth embodiment, which is the process of the first through the twenty-fifth embodiments, wherein (a) contacting a sulfur compound and a polar organic compound further comprises contacting therewith a molecular weight modifying agent.

A twenty-seventh embodiment, which is the process of the twenty-sixth embodiment, wherein the molecular weight modifying agent comprises alkali metal carboxylates, sodium acetate, carboxylic acids, acetic acid, carboxylic anhydrides, acetic anhydride, lithium halides, water, or combinations thereof.

A twenty-eighth embodiment, which is the process of the first through the twenty-seventh embodiments, wherein the polar organic compound comprises N-methyl-2-pyrrolidone.

A twenty-ninth embodiment, which is the process of the first through the twenty-eighth embodiments, wherein at least a portion of the sulfur complex mixture is dehydrated prior to (b) continuously introducing the sulfur complex mixture and at least one halogenated aromatic compound having two halogens to a reaction vessel.

A thirtieth embodiment, which is the process of the first through the twenty-ninth embodiments, wherein at least a portion of the sulfur complex mixture is held in a storage vessel prior to (b) continuously introducing the sulfur complex mixture and at least one halogenated aromatic compound having two halogens to a reaction vessel.

A thirty-first embodiment, which is the process of the first through the thirtieth embodiments, wherein the poly(arylene sulfide) is a poly(phenylene sulfide).

A thirty-second embodiment, which is the process of the first through the thirty-first embodiments, wherein the poly(arylene sulfide) polymer has a molecular weight distribution of from about 1,000 to about 90,000.

A thirty-third embodiment, which is the process of the first through the thirty-second embodiments, wherein the poly(arylene sulfide) polymer has a weight average molecular weight of from about 15,000 g/mol to about 60,000 g/mol.

A thirty-fourth embodiment, which is the process of the first through the thirty-third embodiments, wherein the poly(arylene sulfide) polymer when tested in accordance with ASTM D1238 under a force of 5 kg has a flow rate of from about 1 g/10 min to about 3,000 g/10 min.

A thirty-fifth embodiment, which is a process comprising:

(a) contacting N-methyl-2-pyrrolidone, sodium hydrosulfide and sodium hydroxide to produce a sulfur complex mixture, wherein the sulfur complex mixture comprises sodium N-methyl-4-aminobutanoate;

(b) continuously introducing at least a portion of the sulfur complex mixture and p-dichlorobenzene to a reaction vessel to form a reaction mixture, wherein the reaction vessel is continuously stirred, and wherein the reaction vessel comprises a single reaction zone;

(c) continuously removing a portion of the reaction mixture from the reaction vessel to yield a reaction product mixture; and

(d) processing at least a portion of the reaction product mixture to obtain a poly(phenylene sulfide) polymer, wherein the poly(phenylene sulfide) polymer is a single stage polymerization product.

A thirty-sixth embodiment, which is a process comprising:

(a) contacting sodium hydrosulfide, N-methyl-2-pyrrolidone, acetic anhydride and sodium hydroxide to produce a sulfur complex mixture, wherein the sulfur complex mixture comprises sodium N-methyl-4-aminobutanoate;

(b) dehydrating at least a portion of the sulfur complex mixture to yield a dehydrated sulfur complex mixture;

(c) continuously introducing at least a portion of the dehydrated sulfur complex mixture and p-dichlorobenzene to a reaction vessel to form a reaction mixture, wherein the reaction vessel is continuously stirred, and wherein the reaction vessel comprises a single reaction zone;

(d) continuously removing a portion of the reaction mixture from the reaction vessel to yield a reaction product mixture; and

(e) cooling at least a portion of the reaction product mixture to a temperature of less than about 200° C. to obtain a poly(phenylene sulfide) polymer, wherein the poly(phenylene sulfide) polymer is a single stage polymerization product, and wherein the poly(phenylene sulfide) polymer has a molecular weight distribution of from about 1,000 to about 90,000.

A thirty-seventh embodiment, which is the process of the thirty-sixth embodiment, wherein (e) cooling the reaction product mixture is carried out via quench cooling or evaporative cooling.

A thirty-eighth embodiment, which is the process of the thirty-sixth through the thirty-seventh embodiments, wherein the sulfur complex mixture is continuously dehydrated prior to (c) continuously introducing the dehydrated sulfur complex mixture and p-dichlorobenzene to the reaction vessel.

While embodiments of the disclosure have been shown and described, modifications thereof can be made without departing from the spirit and teachings of the invention. The embodiments and examples described herein are exemplary only, and are not intended to be limiting. Many variations and modifications of the invention disclosed herein are possible and are within the scope of the invention.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the detailed description of the present invention. The disclosures of all patents, patent applications, and publications cited herein are hereby incorporated by reference.

What is claimed is:

1. A process comprising:
(a) contacting a sulfur compound and a polar organic compound to produce a sulfur complex mixture, wherein the sulfur complex mixture comprises a sulfur complex;
(b) continuously introducing at least a portion of the sulfur complex mixture and at least one halogenated aromatic compound having two halogens to a reaction vessel to form a reaction mixture, wherein the reaction vessel is continuously stirred, and wherein the reaction vessel comprises a single reaction zone;
(c) continuously removing a portion of the reaction mixture from the reaction vessel to yield a reaction product mixture; and
(d) processing at least a portion of the reaction product mixture to continuously form a poly(arylene sulfide) polymer, wherein the poly(arylene sulfide) polymer is the product of a single stage polymerization, and the continuously forming poly(arylene sulfide) polymer comprises operating at least two flash units in parallel, wherein a flash unit removes at least a portion of a liquid phase of the reaction product mixture from at least a portion of the reaction product mixture to form a flashed poly(arylene sulfide) polymer mixture, wherein the flashed poly(arylene sulfide) polymer mixture comprises poly(arylene sulfide) polymer particles.

2. The process of claim 1, wherein the poly(arylene sulfide) polymer has a number average molecular weight of from about 10,000 g/mol to about 60,000 g/mol.

3. The process of claim 1, wherein the reaction vessel comprises a single continuous stirred tank reactor.

4. The process of claim 1, wherein the reaction vessel comprises a single continuous reaction volume.

5. The process of claim 1, wherein the reaction vessel excludes reactor partitions, wherein reactor partitions define two or more reaction zones.

6. The process of claim 1, wherein a molecular weight of the poly(arylene sulfide) polymer obtained by (d) processing the reaction product mixture is not increased in a subsequent polymerization reaction.

7. The process of claim 1, wherein the single stage polymerization excludes obtaining a first poly(arylene sulfide) polymer having a first molecular weight and subsequently polymerizing the first poly(arylene sulfide) polymer to yield a second poly(arylene sulfide) polymer having a second molecular weight, wherein the second molecular weight is greater than the first molecular weight.

8. (canceled)

9. The process of claim 1, wherein continuously forming poly(arylene sulfide) polymer particles comprises cooling at least a portion of the reaction product mixture to a temperature of less than about 180° C.

10. The process of claim 1, wherein continuously forming poly(arylene sulfide) polymer particles comprises quenching at least a portion of the reaction product mixture by adding a quench liquid thereto to form a quenched mixture, wherein the quenched mixture comprises poly(arylene sulfide) polymer particles.

11. (canceled)

12. The process of claim 1, wherein the reaction vessel is heated to a temperature of from about 180° C. to about 290° C.

13. The process of claim 1, wherein the reaction vessel has a pressure of from about 0 psig to about 400 psig.

14. The process of claim 1, wherein an equivalent ratio of the halogenated aromatic compound having two halogens to sulfur compound is from about 0.8 to about 2.

15. The process of claim 1, wherein (a) contacting a sulfur compound and a polar organic compound further comprises contacting therewith a molecular weight modifying agent, an alkali metal hydroxide, lithium hydroxide, sodium hydroxide, potassium hydroxide, rubidium hydroxide, cesium hydroxide, or combinations thereof.

16. The process of claim 1, wherein at least a portion of the sulfur complex mixture is dehydrated prior to (b) continuously introducing the sulfur complex mixture and at least one halogenated aromatic compound having two halogens to a reaction vessel.

17. The process of claim 1, wherein the poly(arylene sulfide) polymer has a molecular weight distribution of from about 1,000 to about 90,000.

18. The process of claim 1, wherein the poly(arylene sulfide) polymer has a weight average molecular weight of from about 15,000 g/mol to about 60,000 g/mol.

19. The process of claim 1, wherein the poly(arylene sulfide) polymer when tested in accordance with ASTM D1238 under a force of 5 kg has a flow rate of from about 1 g/10 min to about 3,000 g/10 min.

20. A process comprising:
(a) contacting sodium hydrosulfide, N-methyl-2-pyrrolidone, acetic anhydride and sodium hydroxide to produce a sulfur complex mixture, wherein the sulfur complex mixture comprises sodium N-methyl-4-aminobutanoate;
(b) dehydrating at least a portion of the sulfur complex mixture to yield a dehydrated sulfur complex mixture;
(c) continuously introducing at least a portion of the dehydrated sulfur complex mixture and p-dichlorobenzene to a reaction vessel to form a reaction mixture, wherein the reaction vessel is continuously stirred, and wherein the reaction vessel comprises a single reaction zone;
(d) continuously removing a portion of the reaction mixture from the reaction vessel to yield a reaction product mixture; and
(e) cooling at least a portion of the reaction product mixture to a temperature of less than about 200° C. to continuously form a poly(phenylene sulfide) polymer, wherein the poly(phenylene sulfide) polymer is a single stage polymerization product, and the continuously forming the poly(phenylene sulfide) polymer comprises operating at least two flash units in parallel, wherein a flash unit removes at least a portion of a liquid phase of the reaction product mixture from at least a portion of the reaction product mixture to form a flashed poly(phenylene sulfide) polymer mixture, wherein the flashed poly(phenylene sulfide) polymer mixture comprises poly(phenylene sulfide) polymer particles, and wherein the poly(phenylene sulfide) polymer has a molecular weight distribution of from about 1,000 to about 90,000.
